(19) United States
(12) Patent Application Publication
(10) Pub. No.: US 2026/0304244 A1
(43) Pub. Date: Oct. 1, 2026

(54) METHOD AND APPARATUS FOR PREPARING LTM IN A WIRELESS COMMUNICATION SYSTEM

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/490,186

(22) PCT Filed: Jul. 2, 2024
(86) PCT No.: PCT/KR2024/009304

§ 371 Date: Dec. 4, 2025

(30) Foreign Application Priority Data
Jul. 4, 2023 (IN) 202341044858
Jun. 24, 2024 (IN) 2023 41044858

(51) Int. Cl. H04W 36/00; H04W 36/08

(52) U.S. Cl. CPC H04W 36/0064; H04W 36/08

(57) ABSTRACT

The disclosure relates to a 5G or 6G communication system for supporting a higher data transmission rate. According to an embodiment. Embodiments herein disclose methods for preparing for LTM in a wireless network (1000) by a target network entity (110b). The method includes receiving a handover request message from a source network entity (110a). Further, the method includes performing, on receiving the handover request message, at least one of: preparing for the LTM by reserving at least one resource for the LTM, replacing a prepared LTM candidate configuration, and an unsuccessful LTM preparation. Further, the method includes sending one of: a handover request acknowledge message in response to successfully preparing for the LTM by reserving the at least one resource for the LTM or replacing the prepared LTM candidate configuration based on the handover request message, and a handover preparation failure message to the source network entity (110a) when the LTM preparation is unsuccessful based on the handover request message.

### TECHNICAL FIELD

Embodiments disclosed herein relate to wireless communication networks, and more particularly to preparing for Lower Layers (L1/L2 layers) Triggered Mobility in the wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

The principal object of the embodiments herein is to disclose methods and systems for preparing for LTM in inter-gNB scenarios.

Another object of the embodiments herein is to receive, by a target network entity, a handover request message from a source network entity. The handover request message includes at least one of: a target cell for the LTM, a LTM candidate cell information list, a LTM reference configuration, a LTM reference signal configuration, a cause value informing that a handover request is for the LTM, and a LTM arrival probability.

Another object of the embodiments herein is to prepare, by the target network entity, for the LTM by reserving one or more resource for the LTM on receiving the handover request message.

Another object of the embodiments herein is to replace, by the target network entity, a prepared LTM candidate configuration on receiving the handover request message.

Another object of the embodiments herein is to prepare, by the target network entity, an unsuccessful LTM preparation on receiving the handover request message.

Another object of the embodiments herein is to send, by the target network entity, a handover request acknowledge message in response to successfully preparing for the LTM by reserving the at least one resource for the LTM or replacing the prepared LTM candidate configuration based on the handover request message.

Another object of the embodiments herein is to send, by the target network entity, a handover preparation failure message to the source network entity when the LTM preparation is unsuccessful based on the handover request message.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

Accordingly, the embodiments herein provide a method for preparing for LTM in a wireless network. The method includes receiving, by a target network entity (e.g., target gNB), a handover request message from a source network entity. The handover request message includes at least one of: a target cell for the LTM, a LTM candidate cell information list, a LTM reference configuration, a LTM reference signal configuration, a cause value informing that a handover request is for the LTM, and a LTM arrival probability. Further, the method includes performing, by the target network entity, on receiving the handover request message, at least one of: preparing for the LTM by reserving at least one resource for the LTM, replacing a prepared LTM candidate configuration, and an unsuccessful LTM preparation. Further, the method includes sending, by the target network entity, one of: a handover request acknowledge message in response to successfully preparing for the LTM by reserving the at least one resource for the LTM or replacing the prepared LTM candidate configuration based on the handover request message, and a handover preparation failure message to the source network entity when the LTM preparation is unsuccessful based on the handover request message.

In an embodiment, the handover request acknowledge message includes at least one of: a target cell for the LTM, the LTM reference signal configuration, a Transmission Configuration Indicator (TCI) state configuration, a maximum number of a LTM candidate cell, and an allowable of a subsequent LTM operation.

In an embodiment, the target network entity informs a configuration for a LTM CSI resource configuration for the LTM candidate cell to the source network entity in the handover request acknowledge message.

In an embodiment, the target network entity informs the TCI state configuration for a candidate cell to the source network entity in the handover request acknowledge.

In an embodiment, the target network entity sets a cause value in a handover (HO) preparation failure message to inform the source network entity that the LTM preparation has failed.

In an embodiment, the target network entity informs a requested target cell identifier in a handover preparation failure message to the source network entity, when the handover request message is for preparing LTM and the target network entity rejects the LTM or a failure occurs during the preparation of the LTM.

In an embodiment, the LTM reference configuration, a LTM TCI state configuration and a LTM CSI resource configuration in the handover request message are encoded in a RRC format, and wherein the LTM TCI state configuration and the LTM CSI resource configuration in the handover request acknowledge are encoded in a RRC format.

Accordingly, the embodiments herein provide a method for preparing for LTM in a wireless network. The method includes sending, by a source network entity, a handover request message to a target network entity. The handover request message includes at least one of: a target cell for the LTM, a LTM candidate cell information list, a LTM reference configuration, a LTM reference signal configuration, and a LTM arrival probability. Further, the method includes receiving, by the source network entity, one of: a handover request acknowledge message from the target network entity based on the handover request message, and a handover preparation failure message from the target network entity based on the handover request message.

In an embodiment, the handover request acknowledge message comprises at least one of: a target cell for the LTM, the LTM reference signal configuration, a Transmission Configuration Indicator (TCI) state configuration, a maximum number of a LTM candidate cell, and an allowable of a subsequent LTM operation.

In an embodiment, the source network entity informs a LTM reference signal configuration of a LTM candidate cell to be used for the LTM measurement for all LTM candidate cells and a source cell to the target network entity in the handover request message during the LTM preparation.

In an embodiment, the LTM candidate cell information list sent from the source network entity to the target network entity comprises at least one candidate cell configured by the source network node or other target network node.

In an embodiment, the source network entity informs an LTM CSI resource configuration corresponding to at least one LTM candidate cell that have been configured by the source network entity in the handover request message during the LTM preparation.

In an embodiment, the LTM reference configuration, the LTM TCI state configuration and a LTM CSI resource configuration in the handover request message are encoded in a RRC format, and wherein the LTM TCI state configuration and the LTM CSI resource configuration in handover request acknowledge are encoded in a RRC format.

In an embodiment, the source network entity informs the TCI state configuration for at least one candidate cell to the target network entity in the handover request message during the LTM preparation.

In an embodiment, when the source network entity sends the handover request message to the target network entity requesting for LTM preparation message, the target network entity starts a timer and stops an operation upon an expiry or stopping of the timer.

In an embodiment, the source network entity informs a probability for the LTM to be successful to the target network entity.

Accordingly, the embodiments herein provide a target network entity including a LTM preparation controller coupled with a processor and a memory. The LTM preparation controller is configured to receive a handover request message from a source network entity. The handover request message includes at least one of: a target cell for the LTM, a LTM candidate cell information list, a LTM reference configuration, a LTM reference signal configuration, a cause value that informs that a handover request is for the LTM, and a LTM arrival probability. Further, the LTM preparation controller is configured to perform, on receiving the handover request message, at least one of: preparing for the LTM by reserving at least one resource for the LTM, replacing a prepared LTM candidate configuration, and an unsuccessful LTM preparation. Further, the LTM preparation controller is configured to send one of: a handover request acknowledge message in response to successfully preparing for the LTM by reserving the at least one resource for the LTM or replacing the prepared LTM candidate configuration based on the handover request message, and a handover preparation failure message to the source network entity when the LTM preparation is unsuccessful based on the handover request message.

Accordingly, the embodiments herein provide a source network entity including a LTM preparation controller coupled with a processor and a memory. The LTM preparation controller is configured to send a handover request message to a target network entity. The handover request message includes at least one of: a target cell for the LTM, a LTM candidate cell information list, a LTM reference configuration, a LTM reference signal configuration, and a LTM arrival probability. The LTM preparation controller is configured to receive one of: a handover request acknowledge message from the target network entity based on the handover request message, and a handover preparation failure message from the target network entity based on the handover request message.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts a NG-RAN architecture (from TS 38.401), according to prior arts;

FIG. 2 shows an inter-gNB-DU mobility procedure for an intra-NR, according to prior arts;

FIG. 3 depicts a basic handover scenario where neither an AMF nor an UPF changes, according to prior arts;

FIG. 4 depicts a process of LTM preparation, according to embodiments as disclosed herein;

FIG. 5 depicts a process of LTM preparation replacement, according to embodiments as disclosed herein;

FIG. 6 depicts a scenario, wherein the LTM preparation is unsuccessful, according to embodiments as disclosed herein;

FIG. 7 shows various hardware components of a target network entity, according to the embodiments as disclosed herein;

FIG. 8 shows various hardware components of a source network entity, according to the embodiments as disclosed herein;

FIG. 9 is a flow chart illustrating a method, implemented by the target network entity, for preparing for the LTM in the wireless network, according to the embodiments as disclosed herein;

FIG. 10 is a flow chart illustrating a method, implemented by the source network entity, for preparing for the LTM in the wireless network, according to the embodiments as disclosed herein;

FIG. 11 illustrates various hardware components of a user equipment, according to the embodiments as disclosed herein;

FIG. 12 illustrates various hardware components of a base station, according to the embodiments as disclosed herein; and

FIG. 13 illustrates various hardware components of a network entity, according to the embodiments as disclosed herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

In the disclosure, the word “exemplary” is used herein to mean “serving as an example, instance, or illustration.” Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

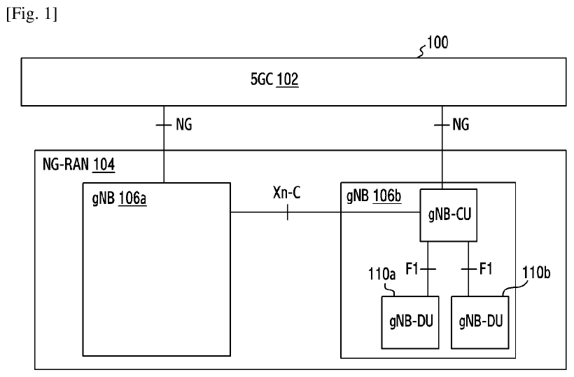

FIG. 1 depicts a NG-RAN architecture (from technical specification (TS) 38.401) (100). The NG-RAN (104) includes a set of gNBs connected to a 5GC (102) through an NG interface. The set of gNBs can be interconnected through an Xn interface. A gNB may comprise of a gNB-CU (108) and one or more gNB-DU(s) (110a, 110b). The gNB-CU (108) and a gNB-DU (110a, 110b) are connected via an F1 interface.

In wireless technologies like fifth generation (5G) new radio (NR), devices can move across different cells. Mobility is performed using a procedure called cell reselection in RRC_IDLE mode. Till NR R17, mobility was performed using a procedure called handover in an RRC_CONNECTED mode. Network controlled mobility applies to UEs (202) in the RRC_CONNECTED mode. It requires explicit RRC signalling to be triggered by the gNB in the NR. Handover in the NR usually includes of three steps: handover preparation step, handover execution step and handover completion step. The gNB may configure the UE (202) to report measurements. Based on the reported measurements or based on its own understanding of the network topology, the gNB will send an RRC Reconfiguration message to handover the UE (202) to another cell (hereinafter referred to as a target cell) from the source cell. The UE (202) accesses the target cell and sends a RRC Reconfiguration complete message. In an alternative way introduced in 3^{rd} Generation Partnership Project (3GPP) NR release 16, the gNB may configure the UE (202) with the execution conditions for triggering handover. Once the execution conditions are satisfied, the UE (202) may move to the target cell and send the RRC Reconfiguration complete. The 3GPP has also introduced a new handover called Dual Active Protocol Stack (DAPS) handover in release 16. In all these methods, the UE (202) performs handover by sending layer 3 (RRC) messages which causes considerable signalling overhead and latency issues. The handover, and conditional handover (CHO) can be referred to as layer 3 mobility. In case of a dual connectivity, the UE (202) may perform PSCellChange or Conditional PSCellChange. In the context of dual connectivity, PSCellChange or Conditional PSCellChange can also be referred to as layer 3 mobility; i.e., Handover, Conditional Handover, PSCellChange, Conditional PSCellChange etc. refers to L3 mobility. The PSCellChange or the Conditional PSCellChange can also be referred to as SCG layer 3 mobility and the handover and CHO as MCG layer 3 mobility in the context of dual connectivity.

Further, the UE (202) may receive the RRC configuration for updating some of the security parameters. For the purposes herein, the 3GPP specifications (such as TS38.300, TS38.331, TS 38.321 V17.4.0) can be considered as relevant background.

3GPP release 18 is considering Lower Layers (L1/L2 layers) Triggered Mobility (LTM) to solve the problem related to latency, signalling overhead etc. associated with layer 3 mobility. As per 3GPP, the goal of LTM is to enable a serving cell change via L1/L2 signalling, in order to reduce the latency, overhead and interruption time. The network (e.g., gNB or the like) may configure the UE (202) with multiple candidate cells to allow fast application of configurations for candidate cells. The network may further send MAC CE or L1 signalling to dynamically switch the UE (202) from a source cell to one of the configured candidate cells. Further, LTM can be triggered based on L1 measurements rather than L3 measurements.

The 3GPP proposes to perform LTM, without reset of lower layers like MAC to avoid data loss and to reduce the additional delay of data recovery, wherever it is possible.

The gNB may provide LTMCandidateConfiguration, i.e., configure LTM candidate cells through one RRCReconfiguration message for a candidate target cell or through one CellGroupConfig for each candidate target cell or through any similar RRC structure or IE containing the similar fields. For example, a new IE LTM-CandidateConfig can be defined as ASN.1 sequence containing CellGroupConfig and some other information elements in the RRCReconfiguration. The gNB may further release or modify the candidate configurations. The UE (202) may store the LTM configuration of other candidate cells even after moving to a candidate cell through LTM. The gNB also may provide the UE (202) with configuration for performing LTM measurements for different candidate frequencies and candidate cells and reporting based on the performed LTM measurements. 3gpp supports subsequent LTM; i.e., after one LTM candidate cell becomes a source cell due to LTM, the UE (202) may store LTM candidate configuration and continue to report LTM measurements (L1 measurements for LTM) and the new serving cell may send LTM cell switch command to the UE (202) and the UE (202) performs LTM. Such an LTM is hereinafter referred to as a subsequent LTM.

### Intra GNB Inter-DU Mobility:

TS 38.401 section 8.2.1 describes L3 mobility for Intra gNB. Inter DU Mobility is described in TS 38.401 section 8.2.1.1. This procedure is used for the case when the UE (202) moves from one gNB-DU (110a) to another gNB-DU (110b) within the same gNB-CU (108) during NR operation.

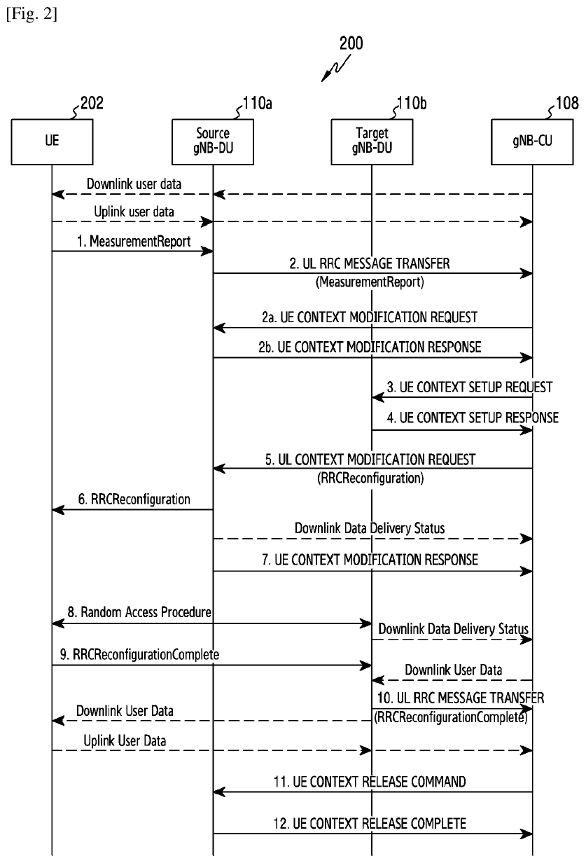

FIG. 2 shows an inter-gNB-DU mobility procedure (200) for intra-NR. In step 1, the UE (202) sends a MeasurementReport message to a source gNB-DU (110a). In step 2, the source gNB-DU (110a) sends an UL RRC MESSAGE TRANSFER message to a gNB-CU (108) to convey the received MeasurementReport message. In step 2a, the gNB-CU (108) may send a UE CONTEXT MODIFICATION REQUEST message to the source gNB-DU (110a) to query the latest configuration. In step 2b, the source gNB-DU (110a) responds with a UE CONTEXT MODIFICATION RESPONSE message that includes full configuration information. In step 3, the gNB-CU (108) sends a UE CONTEXT SETUP REQUEST message to the target gNB-DU (110b) to create a UE context and set up one or more data bearers. The UE CONTEXT SETUP REQUEST message includes a HandoverPreparationInformation. In case of NG-RAN sharing, the gNB-CU (108) includes the serving PLMN ID (for SNPNs the serving SNPN ID). In step 4, the target gNB-DU (110b) responds to the gNB-CU (108) with a UE CONTEXT SETUP RESPONSE message. In step 5, the gNB-CU (108) sends a UE CONTEXT MODIFICATION REQUEST message to the source gNB-DU (110a), which includes a generated RRCReconfiguration message and indicates to stop the data transmission for the UE (202). The source gNB-DU (110a) also sends a Downlink Data Delivery Status frame to inform the gNB-CU (108) about the unsuccessfully transmitted downlink data to the UE (202).

In step 6, the source gNB-DU (110a) forwards the received RRCReconfiguration message to the UE (202). In step 7, the source gNB-DU (110a) responds to the gNB-CU (108) with the UE CONTEXT MODIFICATION RESPONSE message. In step 8, a Random Access procedure is performed at the target gNB-DU (110b). The target gNB-DU (110b) sends a Downlink Data Delivery Status frame to inform the gNB-CU (108). Downlink packets, which may include PDCP PDUs not successfully transmitted in the source gNB-DU (110a), are sent from the gNB-CU (108) to the target gNB-DU (110b).

In step 9, the UE (202) responds to the target gNB-DU (110b) with an RRCReconfigurationComplete message. In step 10, the target gNB-DU (110b) sends an UL RRC MESSAGE TRANSFER message to the gNB-CU (108) to convey the received RRCReconfigurationComplete message. Downlink packets are sent to the UE (202). Also, uplink packets are sent from the UE (202), which are forwarded to the gNB-CU (108) through the target gNB-DU (110b). In step 11, the gNB-CU (108) sends a UE CONTEXT RELEASE COMMAND message to the source gNB-DU (110a). In step 12, the source gNB-DU (110a) releases the UE context and responds the gNB-CU (108) with a UE CONTEXT RELEASE COMPLETE message.

Inter-gNB mobility: Inter-gNB handover is defined in section 9.2.3.2 of TS 38.300; v17.4.0. The intra-NR RAN handover performs the preparation and execution phase of the handover procedure performed without involvement of the 5GC (102). That is, preparation messages are directly exchanged between the gNBs. The release of the resources at the source-gNB (110a) during the handover completion phase is triggered by the target gNB.

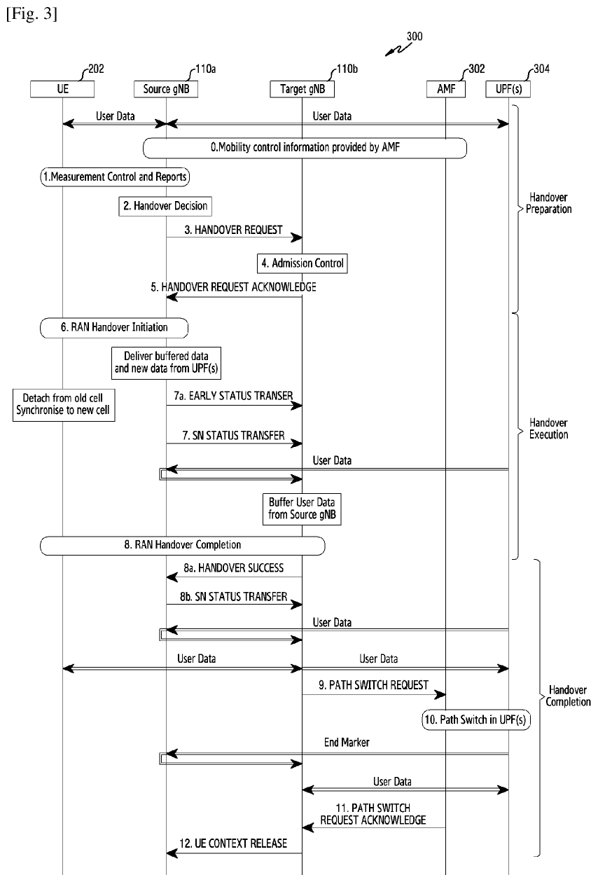

FIG. 3 depicts the basic handover scenario (300) where neither the AMF (302) nor the UPF (304) changes.

In step 0, the UE context within the source gNB contains information regarding roaming and access restrictions which were provided either at connection establishment or at the last TA update. In step 1, the source gNB configures the UE measurement procedures and the UE reports according to the measurement configuration. In step 2, the source gNB decides to handover the UE (202), based on MeasurementReport and RRM information. In step 3, the source gNB issues a Handover Request message to the target gNB passing a transparent RRC container with necessary information to prepare the handover at the target side. The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE (202), the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs.

In step 4, admission control may be performed by the target gNB. Slice-aware admission control shall be performed if the slice information is sent to the target gNB. If the PDU sessions are associated with non-supported slices the target gNB shall reject such PDU Sessions. In step 5, the target gNB prepares the handover with L1/L2 and sends the HANDOVER REQUEST ACKNOWLEDGE to the source gNB, which includes a transparent container to be sent to the UE (202) as an RRC message to perform the handover. The target gNB also indicates if a DAPS handover is accepted.

In step 6, the source gNB triggers the Uu handover by sending an RRCReconfiguration message to the UE (202), containing the information required to access the target cell: at least the target cell ID, the new C-RNTI, the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.

In step 7a, for DRBs configured with DAPS, the source gNB sends the EARLY STATUS TRANSFER message. The DL COUNT value conveyed in the EARLY STATUS TRANSFER message indicates PDCP SN and HFN of the first PDCP SDU that the source gNB forwards to the target gNB. The source gNB does not stop assigning SNs to downlink PDCP SDUs until it sends the SN STATUS TRANSFER message to the target gNB in step 8b.

In step 7, for DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e., for RLC AM). The uplink PDCP SN receiver status includes at least the PDCP SN of the first missing UL PDCP SDU and may include a bit map of the receive status of the out of sequence UL PDCP SDUs that the UE (202) needs to retransmit in the target cell, if any. The downlink PDCP SN transmitter status indicates the next PDCP SN that the target gNB shall assign to new PDCP SDUs, not having a PDCP SN yet.

In step 8, the UE (202) synchronizes to the target cell and completes the RRC handover procedure by sending RRCReconfigurationComplete message to target gNB. In case of DAPS handover, the UE (202) does not detach from the source cell upon receiving the RRCReconfiguration message. The UE (202) releases the source resources and configurations and stops DL/UL reception/transmission with the source upon receiving an explicit release from the target node.

In step 8a/b, in case of DAPS handover, the target gNB sends the HANDOVER SUCCESS message to the source gNB to inform that the UE (202) has successfully accessed the target cell. In return, the source gNB sends the SN STATUS TRANSFER message for DRBs configured with DAPS for which the description in step 7 applies, and the normal data forwarding follows as defined in 9.2.3.2.3.

In step 9, the target gNB sends a PATH SWITCH REQUEST message to AMF (302) to trigger the 5GC (102) to switch the DL data path towards the target gNB and to establish an NG-C interface instance towards the target gNB. In step 10, the 5GC (102) switches the DL data path towards the target gNB. The UPF (304) sends one or more “end marker” packets on the old path to the source gNB per PDU session/tunnel and then can release any U-plane/TNL resources towards the source gNB. In step 11, the AMF (302) confirms the PATH SWITCH REQUEST message with the PATH SWITCH REQUEST ACKNOWLEDGE message. In step 12, on reception of the PATH SWITCH REQUEST ACKNOWLEDGE message from the AMF (302), the target gNB sends the UE CONTEXT RELEASE to inform the source gNB about the success of the handover. The source gNB can then release radio and C-plane related resources associated to the UE context. Any ongoing data forwarding may continue. The RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB. The common RACH configuration for beams in the target cell is only associated to the SSB(s). The network can have dedicated RACH configurations associated to the SSB(s) and/or have dedicated RACH configurations associated to CSI-RS(s) within a cell. The target gNB can only include one of the following RACH configurations in the Handover Command to enable the UE (202) to access the target cell:
i) Common RACH configuration;
ii) Common RACH configuration+Dedicated RACH configuration associated with SSB;
iii) Common RACH configuration+Dedicated RACH configuration associated with CSI-RS.

The dedicated RACH configuration allocates RACH resource(s) together with a quality threshold to use them. When dedicated RACH resources are provided, they are prioritized by the UE (202) and the UE (202) shall not switch to contention-based RACH resources as long as the quality threshold of those dedicated resources is met. The order to access the dedicated RACH resources is up to UE implementation. Upon receiving a handover command requesting DAPS handover, the UE (202) suspends source cell SRBs, stops sending and receiving any RRC control plane signalling toward the source cell, and establishes SRBs for the target cell. The UE (202) releases the source cell SRBs configuration upon receiving source cell release indication from the target cell after successful DAPS handover execution. When DAPS handover to the target cell fails and if the source cell link is available, then the UE (202) reverts back to the source cell configuration and resumes source cell SRBs for control plane signalling transmission.

In the existing 3gpp technologies such as NR, Inter-gNB handovers are always L3 handovers. There is no Inter-gNB LTM in the existing system.

The above information is presented as background information only to help the reader to understand the invention. Applicants have made no determination and make no assertion as to whether any of the above might be applicable as prior art with regard to the application.

The embodiments herein achieve a method for preparing for LTM in a wireless network. The method includes receiving, by a target network entity, a handover request message from a source network entity. The handover request message includes at least one of: a target cell for the LTM, a LTM candidate cell information list, a LTM reference configuration, a LTM reference signal configuration, a cause value informing that a handover request is for the LTM, and a LTM arrival probability. Further, the method includes performing, by the target network entity, on receiving the handover request message, at least one of: preparing for the LTM by reserving at least one resource for the LTM, replacing a prepared LTM candidate configuration, and an unsuccessful LTM preparation. Further, the method includes sending, by the target network entity, one of: a handover request acknowledge message in response to successfully preparing for the LTM by reserving the at least one resource for the LTM or replacing the prepared LTM candidate configuration based on the handover request message, and a handover preparation failure message to the source network entity when the LTM preparation is unsuccessful based on the handover request message.

The method can be used for preparing for LTM in inter-gNB scenarios. The LTM is better than the L3 mobility in terms of latency and it also has lower signaling overhead. It also allows the UE to be synchronized before the actual mobility. In the existing system, the LTM can be performed only for intra-gNB scenarios. The invention enables LTM to be performed for inter-gNB scenarios also.

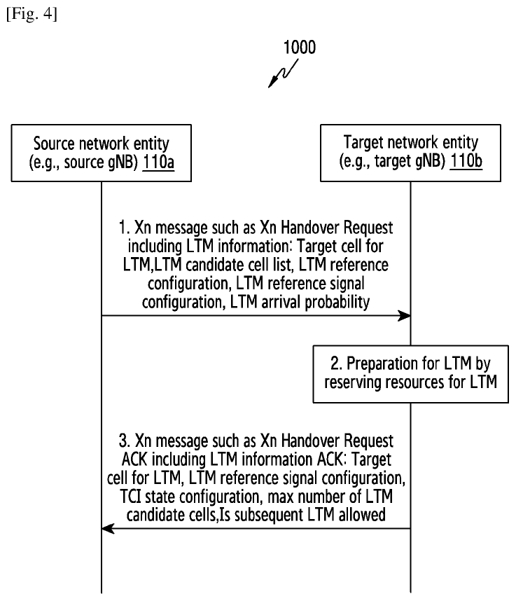

Referring now to the drawings, and more particularly to FIGS. 4 through 10, where similar reference characters denote corresponding features consistently throughout the figures, there are shown at least one embodiment.

The following definitions and abbreviations have been referred to herein:

LTM Candidate Cell Configuration: A configuration associated with an LTM candidate cell. An LTM candidate cell configuration can be a complete LTM candidate cell configuration or a delta (difference) configuration with respect to an LTM reference configuration.

LTM Reference Configuration: A configuration provided by the network to the UE (202) and is used by the UE (202) to generate a complete LTM candidate cell configuration (i.e., by applying an LTM candidate cell configuration on top of an LTM reference configuration). It may be common to all the configured LTM candidate cells or may be configured per a set of LTM candidate cells or may be configured per LTM candidate cell.

Complete LTM Candidate Cell Configuration: A configuration that contains all the necessary fields needed to perform an LTM cell switch procedure. This configuration can be an LTM candidate cell configuration itself or be generated by applying an LTM candidate cell configuration on top of an LTM reference configuration.

LTM candidate cell configurations can be defined as following:

LTM-Config: The IE LTM-Config is used to provide LTM candidate cell configuration.

The LTM-Config information is as follows:

TABLE 1
-- ASN1START
-- TAG-LTM-CONFIG-START
LTM-Config-r18 ::= SEQUENCE {

| | |
|---|---|
| ltm-ReferenceConfiguration-r18 | OCTET STRING (CONTAINING |
| RRCReconfiguration), | OPTIONAL, -- Cond FirstLTM-Candidate |
| ltm-CandidateToReleaseList-r18 | LTM-CandidateToReleaseList-r18 OPTIONAL, |

-- Need N

| | |
|---|---|
| ltm-CandidateToAddModList-r18 | LTM-CandidateToAddModList-r18 OPTIONAL, |

-- Need N

| | |
|---|---|
| ltm-ServingCellNoResetID-r18 | INTEGER (1.. maxNrofCellsLTM-r18) |

OPTIONAL, -- Cond FirstLTM-Only

| | |
|---|---|
| ltm-CSI-ResourceConfigToAddModList-r18 | SEQUENCE (SIZE (1..maxNrofCSI- |

ResourceConfigurations)) OF LTM-CSI-ResourceConfig
OPTIONAL, -- Need N

| | |
|---|---|
| ltm-CSI-ResourceConfigToReleaseList-r18 | SEQUENCE (SIZE (1..maxNrofCSI- |

ResourceConfigurations)) OF LTM-CSI-ResourceConfigId
OPTIONAL, -- Need N ...
LTM-CandidateToReleaseList-r18 ::= SEQUENCE (SIZE (1..maxNrofCellsLTM-r18)) OF

| | |
|---|---|
| LTM-CandidateId-r18 | OPTIONAL -- Need N |

-- TAG-LTM-CONFIG-STOP
-- ASN1STOP

The LTM-CandidateConfig field descriptions are as follows:
a) ltm-CandidateToAddModList: List of LTM candidate cell configurations to add and/or modify.
b) ltm-CandidateToReleaseList: List of LTM candidate cell configurations to remove.
c) ltm-CandidateNoResetL2-List: List of cells where there will be no RLC reestablishment, when they move among those cells.
d) Itm-ServingCellNoResetID: This field is used by the UE (202) to understand on whether no L2 reset should be performed for an LTM candidate cell upon an LTM cell switch procedure. If the value of ltm-NoResetID in an LTM candidate cell is the same as the value of ltm-ServingCellNoResetID in the serving cell of a cell group, then the UE (202) shall not perform any L2 reset during the LTM cell switch procedure.
e) ltm-ReferenceConfiguration: This field includes an RRCReconfiguration message used to configure a reference configuration for LTM.
f) FirstLTM-Candidate: This field is mandatory present upon the first configuration of LTM-Config which includes at least one LTM candidate cell configuration where ltm-ConfigComplete is not present. Otherwise, the field is optionally present, Need M.
g) FirstLTM-Only: This field is mandatory present upon the first configuration of LTM-Config which includes at least one LTM candidate cell configuration. Otherwise, the field is absent, N is needed.
h) LTM-CandidateId: The IE LTM-CandidateId is used to identify an LTM candidate cell configuration.

The LTM-CandidateId information element is as follows:

TABLE 2
-- ASN1START
-- TAG-LTM-CANDIDATEID-START

| | |
|---|---|
| LTM-CandidateId-r18 ::= | INTEGER (1.. maxNrofCellsLTM-r18) |

-- TAG-LTM-CANDIDATEID-STOP
-- ASN1STOP

| | |
|---|---|
| a) | LTM-CandidateToAddModList: The IE LTM-CandidateToAddModList |
| | concerns a list of LTM candidate cell configurations to add or modify. |
| | The LTM-CandidateToAddModList information element is as follows: |

-- ASN1START
-- TAG-LTM-CANDIDATETOADDMODLIST-START
LTM-CandidateToAddModList-r18 ::= SEQUENCE (SIZE (1..maxNrofCellsLTM-
r18)) OF LTM-Candidate-r18

| | |
|---|---|
| LTM-Candidate-r18 ::= | SEQUENCE { |
| ltm-CandidateId-r18 | LTM-CandidateId-r18, |
| ltm-CandidateConfig-r18 | OCTET STRING (CONTAINING |

RRCReconfiguration),

| | |
|---|---|
| ltm-ConfigComplete-r18 | ENUMERATED {true} |

OPTIONAL, -- Need R

| | |
|---|---|
| ltm-EarlyUlSyncConfig-r18 | SetupRelease { EarlyUlSyncConfig- |
| r18 } | OPTIONAL, -- Need M |
| ltm-NoResetID-r18 | INTEGER (1.. maxNrofCellsLTM-r18) |

OPTIONAL, -- Need M

| | |
|---|---|
| ltm-Candidate-Tci-States-ToAddModList-r18 | Candidate-Tci-States-r18 |
| OPTIONAL, -- Need N | |
| ltm-Candidate-Tci-States-ToReleaseList-r18 | Candidate-Tci-StatesId-r18 |

OPTIONAL, -- Need N ...
}
-- TAG-LTM-CANDIDATETOADDMODLIST-STOP
-- ASN1STOP

The LTM-CandidateToAddModList field descriptions are as follows:
a) ltm-CandidateId: This field indicates an LTM candidate cell configuration.
b) ltm-CandidateConfig: This field includes an RRCReconfiguration message used to configure an LTM candidate cell.
c) ltm-ConfigComplete: This field indicates whether the LTM candidate cell configuration within ltm-Config is a complete configuration and thus the UE (202) shall not use the LTM reference configuration within the field ltm-ReferenceConfiguration.
d) ltm-NoResetID: This field indicate whether the UE (202) should perform no L2 reset for an LTM candidate cell upon an LTM cell switch procedure. If the value of ltm-NoResetID in the LTM candidate cell is the same as the value of ltm-ServingCellNoResetID in the serving cell of a cell group, then the UE (202) shall not perform any L2 reset during an LTM cell switch procedure.

The UE (202) performs early TA acquisition upon receiving a PDCCH order from the network to perform early TA acquisition. EarlyUlSyncConfig contains the required configuration for the same.
a) Candidate-Tci-States: The IE Candidate-Tci-States defines a group of one or more TCI states for the early DL synchronization procedure.

The Candidate-Tci-States information element is as follows:

TABLE 3
-- ASN1START
-- TAG-CANDIDATE-TCI-STATES-START
Candidate-Tci-States ::= SEQUENCE {
tci-state TCI State Information OPTIONAL, -- Need M
...
}
-- TAG-CANDIDATE-TCI-STATES-STOP
-- ASN1STOP

a) Candidate-Tci-StatesId: The IE Candidate-Tci-StatesId is used to identify a Candidate-Tci-States.

The Candidate-Tci-StatesId information element is as follows:

TABLE 4

-- ASN1START
-- TAG-CANDIDATE-TCI-STATESID-START
Candidate-Tci-StatesId ::= INTEGER (0.maxValue-1)
-- TAG-LTM-CANDIDATE-TCI-STATESID-STOP
-- ASN1STOP

a) LTM-CSI-ReportConfig: The IE LTM-CSI-ReportConfig is used to configure report on the cell in which the LTM-CSI-ReportConfig is included. FFS on the details.

The LTM-CSI-ReportConfig information element is as follows:

TABLE 5

```
-- ASN1START
-- TAG-LTM-CSI-REPORTCONFIG-START
LTM-CSI-ReportConfig ::= SEQUENCE {
  CSI report configuration related IEs
  ...
}
-- TAG-LTM-CSI-REPORTCONFIG-STOP
-- ASN1STOP
```

LTM-CSI-ResourceConfigId: The IE LTM-CSI-ReportConfigId is used to identify an LTM-CSI-ReportConfig.

The LTM-CSI-ReportConfigId information element is as follows:

TABLE 6
-- ASN1START
-- TAG-LTM-CSI-REPORTCONFIGID-START
LTM-CSI-ReportConfigId ::= INTEGER (0..maxNrofCSI-
ReportConfigurations-1)
-- TAG-LTM-CSI-REPORTCONFIGID-STOP
-- ASN1STOP

a) LTM-CSI-ResourceConfig: The IE LTM-CSI-ResourceConfig defines a group of one or more CSI resources for an LTM candidate cell configuration.

The LTM-CSI-ResourceConfig information element is as follows:

TABLE 7

-- ASN1START
-- TAG-LTM-CSI-RESOURCECONFIG-START
LTM-CSI-ResourceConfig ::= SEQUENCE {
<details of IEs for CSI resource configuration>
}
-- TAG-LTM-CSI-RESOURCECONFIG-STOP
-- ASN1STOP

a) LTM-CSI-ResourceConfigId: The IE LTM-CSI-ResourceConfigId is used to identify an LTM-CSI-ResourceConfig.

The LTM-CSI-ResourceConfigId information element is as follows:

TABLE 8
-- ASN1START
-- TAG-LTM-CSI-RESOURCECONFIGID-START
LTM-CSI-ResourceConfigId ::= INTEGER (0..maxNrofCSI-
ResourceConfigurations-1)
-- TAG-LTM-CSI-RESOURCECONFIGID-STOP
-- ASN1STOP

FIG. 4 depicts the process of the LTM preparation in a wireless network (1000), according to embodiments as disclosed herein. The wireless network (1000) can be, for example, but not limited to a fourth generation (4G) network, a fifth generation (5G) network, a sixth generation (6G) network, and an Open Radio Access Network (ORAN). In an embodiment, the source network entity (110a) and the target network entity (110b) are the same. In another embodiment, the source network entity (110a) and the target network entity (110b) are different. At step 1, the source network entity (110a) sends a Xn message such as Xn handover request including the LTM information, the target cell for the LTM, the LTM candidate cell list, the LTM reference configuration, the LTM reference signal configuration, and the LTM arrival probability to the target network entity (110b). At step 2, the target network entity (110b) prepares for the LTM by reserving resources (e.g., random access resources, signalling resources, processing power, bandwidth, identifiers, radio resources, memory usage or the like) for the LTM. At step 3, the target network entity (110b) sends the Xn message such as Xn handover request acknowledgement including the LTM information acknowledgement, the target cell for the LTM, the LTM reference signal configuration, the TCI state configuration, the maximum number of the LTM candidate cells, and the allowable of the subsequent LTM operation.

In an embodiment, a source RAN node (such as source gNB in NR) (for example) requests the LTM for the UE (202) to the target RAN node (such as a target gNB in NR, also may be referred to as candidate RAN node as the target cell is candidate cell for LTM). That is, the source RAN node informs the target RAN node that the LTM is required for the UE (202). This request is used for LTM preparation (as depicted in FIG. 4, which depicts the process of LTM preparation). The source gNB may inform the target gNB that the LTM needs to be configured for the UE (202) through the Xn (or any other application protocol used for signalling between two RAN nodes in a wireless technology. The Xn may include such application protocols as well). In an embodiment, this request for the LTM preparation uses UE associated signalling. In NR, the source RAN node may send existing Xn handover request (or any other Xn or equivalent application protocol message which may be also a new Xn message) to request the target RAN node for the LTM configuration of the UE (202). The source RAN node includes a target cell identifier (for e.g., Cell global Identifier such as NRC CGI or PCI and ARFCN) and the L3 measurement results and the LTM measurement results (L1 measurements for LTM) in the Xn message.

In an embodiment, the source RAN node informs the target RAN node information about a list of LTM candidate cells that it has configured (already configured and planning to configure). In an embodiment, this information includes one or more of the candidate cell index, the physical cell identifier and NR ARFCN. In an embodiment, this may be communicated using a Xn Handover Request (or equivalent) message. In an embodiment, this may be included in an Xn IE (such as LTM Information Request IE). In an embodiment, this may be communicated using an InterNode-RRC message (such as Handover Preparation Information in NR). In an embodiment, the list of LTM candidate cells may include only the list of LTM candidate cells to which the subsequent LTM may be performed.

The source RAN node may include an IE LTM Information Request IE (or any equivalent new or existing Xn IE) in the Xn message above (such as Xn Handover Request) to request for the LTM preparation. This IE is used to request to establish necessary resources in the target RAN node for an incoming LTM. The source RAN node and the target RAN node may perform parallel transactions for Xn handover request for the LTM. The possible parallel requests are identified by the target cell ID when the source UE AP IDs (which can be a unique identifier for the UE (202) in the source RAN node) are the same.

If an IE (such as LTM Information Request IE) is contained in the Xn message such as HANDOVER REQUEST message, the target RAN node performs LTM related actions such as LTM preparation, reserving necessary resources for LTM and may send an acknowledgment to the source RAN node by including an IE (for e.g., LTM Information Acknowledge IE) acknowledging that LTM preparation is successfully done in the Xn message such as HANDOVER REQUEST ACKNOWLEDGE message.

In an embodiment, the assigned criticality of LTM Information Request IE (or equivalent IE) is reject (definition of criticality is as per/as referenced in the TS 38.423).

In an embodiment, the assigned criticality of LTM Information Request Acknowledge IE (or equivalent IE) is reject.

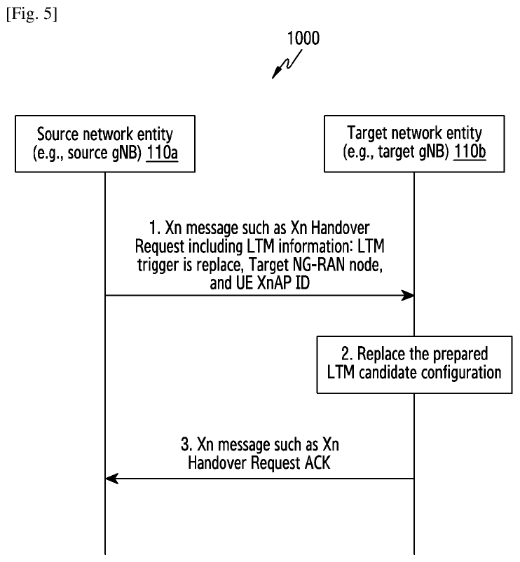

FIG. 5 depicts the process of the LTM preparation replacement in the wireless network (1000), according to embodiments as disclosed herein. At step 1, the source network entity (110a) sends the Xn message such as Xn handover request message including the LTM information, replacing of the LTM trigger, the target NG-RAN node and the UE XnAP ID to the target network entity (110b). At step 2, the target network entity (110b) replaces the prepared LTM candidate configuration. At step 3, the target network entity (110b) sends the Xn message such as Xn handover request acknowledgment to the source network entity (110a).

In an embodiment, the source RAN node requests the target RAN node to replace the LTM configuration (such as the prepared LTM candidate cell configuration) for a LTM candidate cell for the UE (202) (as depicted in FIG. 5). In an embodiment, the source RAN node may inform the target RAN node that the procedure is triggered for replacing the LTM configuration by setting an IE such as LTM-Trigger as replace in the Xn HandoverRequest message.

In an embodiment, the source RAN node informs the LTM reference configuration to be used for LTM to the target RAN node. In an embodiment, this may be included in Xn Handover request message. In an embodiment, this may be included in Inter-Node RRC message used during LTM preparation (for e.g., Handover Preparation Request Inter-Node RRC message).

In an embodiment, the target RAN node informs the configuration for the reference signals to be used for LTM measurements for a LTM candidate cell in target RAN node to the source RAN node. In an embodiment, this may be included in an Xn Handover Acknowledge request. In an embodiment, this may be included in Inter-Node RRC message used during LTM preparation. The reference signal configuration sent by the target RAN node to the source RAN node can be SSB configuration or CSI-RS configuration. The SSB configuration may include PCI or logical ID (such as LTM candidate cell identifier), subcarrier spacing, SMTC configuration, and the frequency information. The source RAN node may include the received configured reference signals for LTM measurements in the LTM candidate cell configuration to the UE (202).

In an embodiment, the target RAN node informs the configuration for the LTM CSI Resource configuration for a LTM candidate cell in the target RAN node to the source RAN node. In an embodiment, this may be included in Xn Handover Acknowledge request (for e.g. as IEs encoded in the Xn format). In an embodiment, this may be included in Inter-Node RRC message used during LTM preparation. The source RAN node may use this information for handling LTM measurements, configuring the UE (202) and may store it for subsequent LTM.

In an embodiment, the source RAN node informs configuration for the reference signals of LTM candidate cells (in the source RAN node or other target RAN nodes) to be used for LTM measurements for all the LTM candidate cells and the source cell to the target RAN node. In an embodiment, this may be included in Xn Handover request (for example, as IEs encoded in the Xn format). In an embodiment, this may be included in Inter-Node RRC message used during LTM preparation (for e.g., Handover Preparation Request Inter-Node RRC message). The reference signal configuration sent by the source RAN node to the target RAN node can be SSB configuration or CSI-RS configuration. SSB configuration may include PCI or logical ID (candidate cell identifier), subcarrier spacing, SMTC configuration, and the frequency information.

In an embodiment, the source RAN node informs the configuration for the LTM CSI Resource configuration corresponding to the LTM candidate cells that have been configured (Inter-gNB and Intra-gNB) by the source RAN node or other target RAN nodes. In an embodiment, this may be included in the Xn Handover request (for example, as IEs encoded in the Xn format). In an embodiment, this may be included in the Inter-Node RRC message used during LTM preparation. The target RAN node may use this information for handling LTM measurements, configuring the UE (202) and may store it for subsequent LTMs.

In an embodiment, the source RAN node informs configurations of TCI states for the candidate cells to the target RAN node. In an embodiment, this may be included in the Xn Handover request (for example, as IEs encoded in the Xn format). In an embodiment, this may be included in Inter-Node RRC message used during LTM preparation sent by the source RAN node. The target RAN node may include the received configurations of TCI states for the candidate cells in the LTM candidate cell configuration to the UE (202) during subsequent LTM.

In an embodiment, the target RAN node informs configurations of TCI states for the candidate cells to the source RAN node. In an embodiment, this may be included in the Xn Handover Request Acknowledge (for example, as IEs encoded in the Xn format). In an embodiment, this may be included in the Inter-Node RRC message used during LTM preparation sent by the target RAN node. The source RAN node may include the received configurations of TCI states for the candidate cells in the LTM candidate cell configuration to the UE (202).

When the source RAN node sends the Xn message to the target RAN requesting for LTM preparation message, it may start a timer and upon the expiry or stopping of the timer, stop the procedure. The source RAN node may cancel the LTM preparation at the target RAN node.

If the target RAN node, UE XnAP ID IE is contained in the LTM Information Request IE or any equivalent IE (as mentioned in the Xn HANDOVER REQUEST message send from the source RAN node), then the target RAN node may remove the existing prepared LTM identified by, the target NG-RAN node (104), UE XnAP ID IE and the Target Cell Global ID IE.

In an embodiment, the target RAN node may inform the source RAN node that the maximum number of LTM candidate cells that the source RAN node can prepare for the UE (202) through the Xn message such as HANDOVER REQUEST ACKNOWLEDGE message.

For example, in the NR, if the maximum number of LTM preparations IE is included in the LTM Information Acknowledge IE contained in the HANDOVER REQUEST ACKNOWLEDGE message, then the source NG-RAN node may not prepare more candidate target cells for a LTM for the same UE (202) towards the target NG-RAN node than the number indicated in the IE.

The source RAN node may inform the target RAN node the probability for the LTM to be successful, i.e., the probability that the LTM will be performed towards a LTM candidate cell in the target gNB. In an embodiment, this probability is for the current source cell. In an embodiment, this probability is for the current source cell and other LTM candidate cells for which LTM could be performed.

The target RAN node may inform the source RAN node whether a LTM candidate cell supports subsequent LTM; i.e., if the LTM candidate cell needs to be released after a successful LTM to another cell. In an embodiment, the target RAN node may inform the source RAN node whether it supports subsequent LTM. Alternatively, the target RAN node may inform the source RAN node whether it supports subsequent LTM for a specific UE. In an embodiment, if the target RAN node does not support subsequent LTM, all the LTM candidate cells for all the UEs will be released after a successful LTM to another cell by the source RAN Node or the RAN node of the new serving cell. In an embodiment, if the target RAN node does not support subsequent LTM for a UE (202), all the LTM candidate cells for this UE (202) will be released after a successful LTM to another cell for this UE (202) by the source RAN Node or the RAN node of the new serving cell. In another embodiment, if the target RAN node does not support subsequent LTM for the UE (202) for a LTM candidate cell, the specific LTM candidate cells will be released after a successful LTM to another cell for this UE (202) by the source RAN Node or the RAN node of the new serving cell.

In an embodiment, the target RAN node sets the cause value for the Xn Handover Request to LTM (or any value which tells that this Xn Handover Request is for LTM).

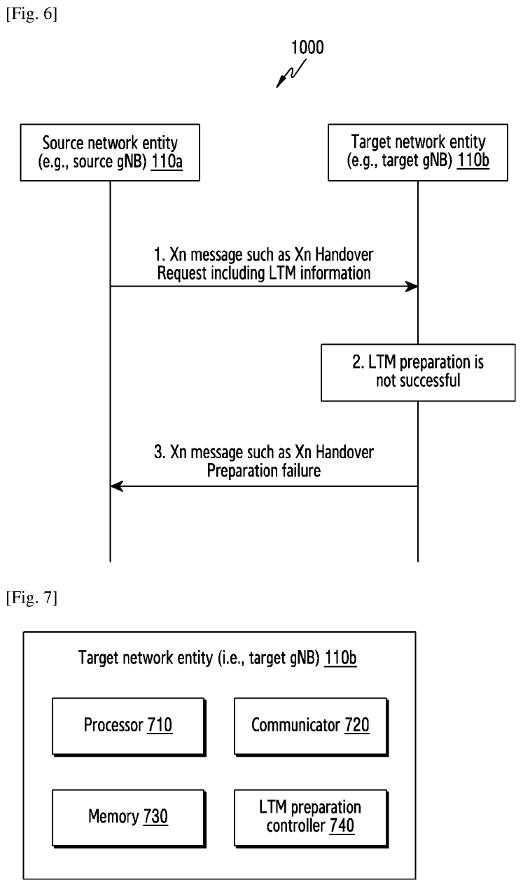

FIG. 6 depicts a scenario, wherein the LTM preparation is unsuccessful in the wireless network (1000). At step 1, the source network entity (110a) sends the Xn message such as Xn handover request message including the LTM information to the target network entity (110b). At step 2, the target network entity (110b) determines that the LTM preparation is not successful. At step 3, the target network entity (110b) sends the Xn message such as Xn handover preparation failure message to the source network entity (110a).

In an embodiment, if the target RAN node is unable to accept the LTM preparation, it sends a failure message for the request for LTM preparation (i.e., it sends a failure message for the Xn Handover Request message). In an embodiment, for NR, the failure message is HO preparation failure message. The target gNB sets the cause value in the HO preparation failure message to inform the source gNB that the LTM preparation has failed.

If the LTM Information Request IE is included in the HANDOVER REQUEST message and the target RAN node rejects the LTM or a failure occurs during the preparation of the LTM, the target RAN node informs the source RAN node the requested target cell identifier in the HANDOVER PREPARATION FAILURE message.

In an embodiment, if the IE (such as LTM trigger IE) is set to “LTM-replace” in the Xn HANDOVER REQUEST message, but there is no LTM candidate cell prepared for the included Target NG-RAN node UE XnAP ID, or the candidate cell in the Target Cell ID IE was not prepared using the same UE-associated signaling connection, the NG-RAN node rejects the procedure using the HANDOVER PREPARATION FAILURE message.

The messages as disclosed herein (such as Handover Request, Handover Request Acknowledge, Handover Preparation Failure, and so on) also refer to any equivalent message which provides equivalent functionality in another radio access technology.

An example specification (only the relevant IEs for LTM are shown below) including changes in TS 38.423 is given as below:

HANDOVER REQUEST: This message is sent by the source NG-RAN node to the target NG-RAN node to request the preparation of resources for a handover. The LTM related IEs are encoded in Xn ASN.1 format in this message unless mentioned as encoded in RRC ASN.1 format or TS 38.331 ASN.1 format.

Direction: source NG-RAN node→target NG-RAN node.

TABLE 9

| IE/Group | | | IE type and | | | Assigned |
|---|---|---|---|---|---|---|
| Name | Presence | Range | reference | Semantics description | Criticality | Criticality |
| Message | M | | 9.2.3.1 | | YES | reject |
| Type | (Manda- | | | | | |
| | tory) | | | | | |
| Source NG- | M | | NG-RAN | Allocated at the source | YES | reject |
| RAN node | | | node UE | NG-RAN node | | |
| UE XnAP | | | XnAP ID | | | |
| ID reference | | | 9.2.3.16 | | | |
| Cause | M | | 9.2.3.2 | | YES | reject |
| Target Cell | M | | 9.2.3.25 | Includes either an E- | YES | reject |
| Global ID | | | | UTRA CGI or an NR CGI | | |
| GUAMI | M | | 9.2.3.24 | | YES | reject |
| UE Context | | 1 | | | YES | reject |
| Information | | | | | | |
| >NG-C UE | M | | AMF UE | Allocated at the AMF on | — | |
| associated | | | NGAP ID | the source | | |
| Signalling | | | 9.2.3.26 | NG-C | | |
| reference | | | | connection. | | |
| >Signalling | M | | CP | This IE indicates the | — | |
| TNL | | | Transport | AMF's IP address of the | | |
| association | | | Layer | SCTP association used at | | |
| address at | | | Information | the source NG-C interface | | |
| source NG- | | | 9.2.3.31 | instance. | | |
| C side | | | | Note: If no UE TNLA | | |
| | | | | binding exists at the source | | |
| | | | | NG-RAN node, the source | | |
| | | | | NG-RAN node indicates | | |
| | | | | the TNL association | | |
| | | | | address it would have | | |
| | | | | selected if it would have | | |
| | | | | had to create a UE TNLA | | |
| | | | | binding. | | |
| >UE | M | | 9.2.3.49 | | — | |
| Security | | | | | | |
| Capabilities | | | | | | |
| >AS | M | | 9.2.3.50 | | — | |
| Security | | | | | | |
| Information | | | | | | |
| >Index to | O | | 9.2.3.23 | | — | |
| RAT/ | (Optional) | | | | | |
| Frequency | | | | | | |
| Selection | | | | | | |
| Priority | | | | | | |
| >UE | M | | 9.2.3.17 | | — | |
| Aggregate | | | | | | |
| Maximum | | | | | | |
| Bit Rate | | | | | | |
| >PDU | | 1 | 9.2.1.1 | Similar to NG-C | — | |
| Session | | | | signalling, containing UL | | |
| Resources | | | | tunnel information per | | |
| To Be | | | | PDU Session Resource; | | |
| Setup List | | | | and in addition, the source | | |
| | | | | side QoS flow ⇔ DRB | | |
| | | | | mapping | | |
| >RRC | M | | OCTET | Either includes the | — | |
| Context | | | STRING | HandoverPreparationInfo | | |
| | | | | rmation message as | | |
| | | | | defined in subclause | | |
| | | | | 10.2.2. of TS 36.331, or the | | |
| | | | | HandoverPreparation | | |
| | | | | Information-NB | | |
| | | | | message as defined | | |
| | | | | in subclause 10.6.2 | | |
| | | | | of TS 36.331, if the target | | |
| | | | | NG-RAN node is an ng- | | |
| | | | | eNB, | | |
| | | | | or the | | |
| | | | | HandoverPreparation | | |
| | | | | Information message as | | |
| | | | | defined in subclause 11.2.2 | | |
| | | | | of TS 38.331 if the target | | |
| | | | | NG-RAN node is a gNB. | | |
| >Location | O | | 9.2.3.47 | Includes the necessary | — | |
| Reporting | | | | parameters for location | | |
| Information | | | | reporting. | | |
| >Mobility | O | | 9.2.3.53 | | — | |
| Restriction | | | | | | |
| List | | | | | | |
| >5GC | O | | 9.2.3.100 | | YES | ignore |
| Mobility | | | | | | |
| Restriction | | | | | | |
| List | | | | | | |
| Container | | | | | | |
| >NR UE | O | | 9.2.3.107 | This IE applies only if the | YES | ignore |
| Sidelink | | | | UE is authorized for NR | | |
| Aggregate | | | | V2X services. | | |
| Maximum | | | | | | |
| Bit Rate | | | | | | |
| >LTE UE | O | | 9.2.3.108 | This IE applies only if the | YES | ignore |
| Sidelink | | | | UE is authorized for LTE | | |
| Aggregate | | | | V2X services. | | |
| Maximum | | | | | | |
| Bit Rate | | | | | | |
| >Manage- | O | | MDT PLMN | | YES | ignore |
| ment Based | | | List | | | |
| MDT | | | 9.2.3.133 | | | |
| PLMN List | | | | | | |
| >UE Radio | O | | 9.2.3.138 | | YES | reject |
| Capability | | | | | | |
| ID | | | | | | |
| >MBS | O | | 9.2.1.36 | | YES | ignore |
| Session | | | | | | |
| Information | | | | | | |
| List | | | | | | |
| >5G ProSe | O | | NR UE | This IE applies only if the | YES | ignore |
| UE PC5 | | | Sidelink | UE is authorized for 5G | | |
| Aggregate | | | Aggregate | ProSe services. | | |
| Maximum | | | Maximum | | | |
| Bit Rate | | | Bit Rate | | | |
| | | | 9.2.3.107 | | | |
| >UE Slice | O | | 9.2.3.167 | | YES | ignore |
| Maximum | | | | | | |
| Bit Rate | | | | | | |
| List | | | | | | |
| Trace | O | | 9.2.3.55 | | YES | ignore |
| Activation | | | | | | |
| Masked | O | | 9.2.3.32 | | YES | ignore |
| IMEISV | | | | | | |
| UE History | M | | 9.2.3.64 | | YES | ignore |
| Information | | | | | | |
| UE Context | O | | | | YES | ignore |
| Reference at | | | | | | |
| the S-NG- | | | | | | |
| RAN node | | | | | | |
| >Global | M | | 9.2.2.3 | | — | |
| NG-RAN | | | | | | |
| Node ID | | | | | | |
| >S-NG- | M | | NG-RAN | | — | |
| RAN node | | | node UE | | | |
| UE XnAP | | | XnAP ID | | | |
| ID | | | 9.2.3.16 | | | |
| LTM | O | | | | YES | reject |
| Information | | | | | | |
| Request | | | | | | |
| >LTM | M | | ENUMERA | | — | |
| Trigger | | | TED (LTM- | | | |
| | | | initiation, | | | |
| | | | LTM- | | | |
| | | | replace, . . . ) | | | |
| >Target | C- | | NG-RAN | Allocated at the target NG- | — | |
| NG-RAN | ifLTMm | | node UE | RAN node | | |
| node UE | od | | XnAP ID | | | |
| XnAP ID | | | 9.2.3.16 | | | |
| >Estimated | O | | INTEGER | | — | |
| Arrival | | | (1 . . . 100) | | | |
| Probability | | | | | | |
| >LTM | O | | OCTET | Includes the LTM | Yes | ignore |
| Reference | | | STRING | reference configuration as | | |
| configuration | | | | defined in TS 38.331 | | |
| | | | | encoded in RRC ASN.1 | | |
| | | | | format. | | |
| >LTM | O | | OCTET | Includes the LTM | Yes | reject |
| measurement | | | STRING | measurement reference | | |
| reference | | | | signal configuration as | | |
| signal | | | | defined below | | |
| configuration | | | | | | |
| >TCI state | O | | OCTET | Includes the TCI state | Yes | ignore |
| configuration | | | STRING | configuration | | |
| Mobility | O | | BIT | Information related to the | YES | ignore |
| Information | | | STRING | handover; the source NG- | | |
| | | | (SIZE (32)) | RAN node provides it in | | |
| | | | | order to enable later | | |
| | | | | analysis of the conditions | | |
| | | | | that led to a wrong HO. | | |
| UE History | O | | 9.2.3.110 | | YES | ignore |
| Information | | | | | | |
| from the UE | | | | | | |

TABLE 10

| Condition | Explanation |
|---|---|
| ifLTMmod | This IE shall be present if the |
| | LTM Trigger IE is present and |
| | set to “LTM-replace”. |

The LTM measurement reference signal configuration is defined as below and is encoded in RRC ASN.1 format as given below:

```
TABLE 11
LTM-ReferenceSignalConfiguration SEQUENCE {
ssb-ToMeasure SSB-ToMeasure
ssbFrequency ARFCN-ValueNR
OPTIONAL,
  ssbSubcarrierSpacing SubcarrierSpacing
  OPTIONAL,
  smtc1 SSB-MTC
  OPTIONAL,
  smtc2 SSB-MTC2
  OPTIONAL,
  refFreqCSI-RS ARFCN-ValueNR
  OPTIONAL,
  CSI-RS-Resource-Mobility ::= SEQUENCE {
  csi-RS-Index CSI-RS-Index,
  slotConfig CHOICE {
    ms4 INTEGER (0..31),
    ms5 INTEGER (0..39),
    ms10 INTEGER (0..79),
    ms20 INTEGER (0..159),
    ms40 INTEGER (0..319)
  },
  associatedSSB SEQUENCE {
    ssb-Index SSB-Index,
    isQuasiColocated BOOLEAN
  }
  OPTIONAL, -- Need R
  frequencyDomainAllocation CHOICE {
    row1 BIT STRING (SIZE (4)),
    row2 BIT STRING (SIZE (12))
  },
  firstOFDMSymbolInTimeDomain INTEGER (0..13),
  sequenceGenerationConfig INTEGER (0..1023),
  ...,
  [[
  slotConfig-r17 CHOICE {
    ms4 INTEGER (0..255),
    ms5 INTEGER (0..319),
    ms10 INTEGER (0..639),
    ms20 INTEGER (0..1279),
    ms40 INTEGER (0..2559)
  }
  ]]
}
CSI-RS-Index ::= INTEGER (0..maxNrofCSI-RS-ResourcesRRM-1)
}
```

### Handover Request Acknowledge:

This message is sent by the target NG-RAN node to inform the source NG-RAN node about the prepared resources at the target. LTM related IEs are encoded in Xn ASN.1 format in this message, unless mentioned as encoded in RRC ASN.1 format or TS 38.331 ASN.1 format.

Direction: target NG-RAN node→source NG-RAN node.

TABLE 12

| IE/Group | | | IE type and | | | Assigned |
|---|---|---|---|---|---|---|
| Name | Presence | Range | reference | Semantics description | Criticality | Criticality |
| Message | M | | 9.2.3.1 | | YES | reject |
| Type | | | | | | |
| Source NG- | M | | NG-RAN | Allocated at the source | YES | ignore |
| RAN node | | | node UE | NG-RAN node | | |
| UE XnAP | | | XnAP ID | | | |
| ID | | | 9.2.3.16 | | | |
| Target NG- | M | | NG-RAN | Allocated at the target | YES | ignore |
| RAN node | | | node UE | NG-RAN node | | |
| UE XnAP | | | XnAP ID | | | |
| ID | | | 9.2.3.16 | | | |
| PDU | M | | 9.2.1.2 | | YES | ignore |
| Session | | | | | | |
| Resources | | | | | | |
| Admitted | | | | | | |
| List | | | | | | |
| PDU | O | | 9.2.1.3 | | YES | ignore |
| Session | | | | | | |
| Resources | | | | | | |
| Not | | | | | | |
| Admitted | | | | | | |
| List | | | | | | |
| Target NG- | M | | OCTET | Either includes the | YES | ignore |
| RAN node | | | STRING | HandoverCommand | | |
| To Source | | | | message as defined in | | |
| NG-RAN | | | | subclause 10.2.2 of TS | | |
| node | | | | 36.331, if the target NG- | | |
| Transparent | | | | RAN node is an ng-eNB, | | |
| Container | | | | or the | | |
| | | | | HandoverCommand | | |
| | | | | message as defined in | | |
| | | | | subclause 11.2.2 of TS | | |
| | | | | 38.331 if the target NG- | | |
| | | | | RAN node is a gNB. | | |
| UE Context | O | | 9.2.3.68 | | YES | ignore |
| Kept | | | | | | |
| Indicator | | | | | | |
| Criticality | O | | 9.2.3.3 | | YES | ignore |
| Diagnostics | | | | | | |
| DRBs | O | | DRB List | In case of DC, indicates | YES | ignore |
| transferred | | | 9.2.1.29 | that SN Status is needed | | |
| to MN | | | | for the listed DRBs from | | |
| | | | | the S-NG-RAN node. | | |
| DAPS | O | | 9.2.1.34 | | YES | reject |
| Response | | | | | | |
| Information | | | | | | |
| LTM | O | | | | YES | reject |
| Information | | | | | | |
| Acknowledge | | | | | | |
| >Requested | M | | Target Cell | Target cell indicated in | — | |
| Target | | | Global ID | the corresponding | | |
| Cell ID | | | 9.2.3.25 | HANDOVER REQUEST | | |
| | | | | message | | |
| >Maximum | O | | 9.x.x.x | | — | |
| Number | | | | | | |
| of LTM | | | | | | |
| Preparations | | | | | | |
| >LTM | O | | OCTET | Includes the LTM | Yes | reject |
| measurement | | | STRING | measurement reference | | |
| reference | | | | signal configuration as | | |
| signal | | | | defined in LTM- | | |
| configuration | | | | ReferenceSignalConfiguration. | | |
| >TCI state | O | | OCTET | Includes the TCI state | Yes | ignore |
| configuration | | | STRING | configuration | | |
| >Subsequent | O | | ENUMER- | | Yes | ignore |
| LTM | | | ATED | | | |
| support | | | (supported, | | | |
| | | | not supported, | | | |
| | | | . . . ) | | | |
| >LTM CSI | O | | | Includes the CSI resource | Yes | reject |
| Resource | | | | configuration for LTM | | |
| Configuration | | | | | | |
| MBS | O | | 9.2.1.38 | | YES | ignore |
| Session | | | | | | |
| Information | | | | | | |
| Response | | | | | | |
| List | | | | | | |

HANDOVER PREPARATION FAILURE: This message is sent by the target NG-RAN node to inform the source NG-RAN node that the Handover Preparation has failed.

Direction: target NG-RAN node→source NG-RAN node.

TABLE 13

| | | | IE type | | | |
|---|---|---|---|---|---|---|
| IE/Group | | | and | Semantics | | Assigned |
| Name | Presence | Range | reference | description | Criticality | Criticality |
| Message | M | | 9.2.3.1 | | YES | reject |
| Type | | | | | | |
| Source NG- | M | | NG-RAN | Allocated at the | YES | ignore |
| RAN node | | | node UE | source NG- | | |
| UE XnAP | | | XnAP ID | RAN node | | |
| ID | | | 9.2.3.16 | | | |
| Cause | M | | 9.2.3.2 | A specific cause | YES | ignore |
| | | | | value indicates | | |
| | | | | the failure for | | |
| | | | | LTM | | |
| | | | | preparation. | | |
| Criticality | O | | 9.2.3.3 | | YES | ignore |
| Diagnostics | | | | | | |
| Requested | O | | Target Cell | Target cell | YES | reject |
| Target Cell | | | Global ID | indicated in the | | |
| ID | | | 9.2.3.25 | corresponding | | |
| | | | | HANDOVER | | |
| | | | | REQUEST | | |
| | | | | message | | |

In an embodiment, some of the above embodiments may be represented by below structures and definitions in TS 38.331.

```
TABLE 14
HandoverPreparationInformation-IEs ::= SEQUENCE {
  ue-CapabilityRAT-List UE-CapabilityRAT-ContainerList,
  sourceConfig AS-Config
OPTIONAL, -- Cond HO
  rrm-Config  RRM-Config
OPTIONAL,
  as-Context  AS-Context
OPTIONAL,
  nonCriticalExtension SEQUENCE { }
OPTIONAL
}
AS-Config ::= SEQUENCE {
  rrcReconfiguration OCTET STRING (CONTAINING
RRCReconfiguration),
  ....,
  [[
  sourceRB-SN-Config OCTET STRING (CONTAINING
RadioBearerConfig) OPTIONAL,
  sourceSCG-NR-Config OCTET STRING (CONTAINING
RRCReconfiguration) OPTIONAL,
  sourceSCG-EUTRA-Config OCTET STRING
OPTIONAL
  ]],
  [[
  sourceSCG-Configured ENUMERATED {true}
OPTIONAL
  ]],
  [[
  sdt-Config-r17 SDT-Config-r17
OPTIONAL
  ]],
      [[
      lTM-information-r19 LTM-Information-r19 OPTIONAL,
  ]]
}
AS-Context ::= SEQUENCE {
  reestablishmentInfo ReestablishmentInfo
OPTIONAL,
  configRestrictInfo ConfigRestrictInfoSCG
OPTIONAL,
  ...,
  [[ ran-NotificationAreaInfo RAN-NotificationAreaInfo
OPTIONAL
  ]],
  [[ ueAssistanceInformation OCTET STRING (CONTAINING
UEAssistanceInformation) OPTIONAL -- Cond HO2
  ]],
  [[
  selectedBandCombinationSN  BandCombinationInfoSN
OPTIONAL
  ]],
  [[
  configRestrictInfoDAPS-r16  ConfigRestrictInfoDAPS-r16
OPTIONAL,
  sidelinkUEInformationNR-r16  OCTET STRING
OPTIONAL,
  sidelinkUEInformationEUTRA-r16  OCTET STRING
OPTIONAL,
  ueAssistanceInformationEUTRA-r16  OCTET STRING
OPTIONAL,
  ueAssistanceInformationSCG-r16  OCTET STRING (CONTAINING
UEAssistanceInformation) OPTIONAL, -- Cond HO2
  needForGapsInfoNR-r16  NeedForGapsInfoNR-r16
OPTIONAL
  ]],
  [[
  configRestrictInfoDAPS-v1640  ConfigRestrictInfoDAPS-v1640 OPTIONAL
  ]],
  [[
  needForGapNCSG-InfoNR-r17  NeedForGapNCSG-InfoNR-r17
OPTIONAL,
  needForGapNCSG-InfoEUTRA-r17  NeedForGapNCSG-InfoEUTRA-r17
OPTIONAL,
  mbsInterestIndication-r17  OCTET STRING (CONTAINING
MBSInterestIndication-r17) OPTIONAL
  ]]
}
ConfigRestrictInfoDAPS-r16 ::= SEQUENCE {
  powerCoordination-r16  SEQUENCE {
    p-DAPS-Source-r16  P-Max,
    p-DAPS-Target-r16  P-Max,
    uplinkPowerSharingDAPS-Mode-r16  ENUMERATED {semi-static-mode1,
semi-static-mode2, dynamic }
  }
OPTIONAL
}
ConfigRestrictInfoDAPS-v1640 ::= SEQUENCE {
  sourceFeatureSetPerDownlinkCC-r16 FeatureSetDownlinkPerCC-Id,
  sourceFeatureSetPerUplinkCC-r16 FeatureSetUplinkPerCC-Id
}
ReestablishmentInfo ::=  SEQUENCE {
  sourcePhysCellId PhysCellId,
  targetCellShortMAC-I  ShortMAC-I,
  additionalReestabInfoList ReestabNCellInfoList
OPTIONAL
}
ReestabNCellInfoList ::= SEQUENCE ( SIZE (1..maxCellPrep) ) OF
ReestabNCellInfo
ReestabNCellInfo ::= SEQUENCE{
  cellIdentity CellIdentity,
  key-gNodeB-Star BIT STRING (SIZE (256)),
  shortMAC-I ShortMAC-I
}
RRM-Config ::= SEQUENCE {
  ue-InactiveTime ENUMERATED {
        s1, s2, s3, s5, s7, s10, s15, s20,
        s25, s30, s40, s50, min1, min1s20, min1s40,
        min2, min2s30, min3, min3s30, min4, min5, min6,
        min7, min8, min9, min10, min12, min14, min17, min20,
        min24, min28, min33, min38, min44, min50, hr1,
        hr1min30, hr2, hr2min30, hr3, hr3min30, hr4, hr5, hr6,
        hr8, hr10, hr13, hr16, hr20, day1, day1hr12, day2,
        day2hr12, day3, day4, day5, day7, day10, day14, day19,
        day24, day30, dayMore Than30}
OPTIONAL,
  candidateCellInfoList  MeasResultList2NR
OPTIONAL,
  ...,
  [[
  candidateCellInfoListSN-EUTRA MeasResultServFreqListEUTRA-SCG
OPTIONAL
  ]],
[[
LTMcandidateCellInfoList SEQUENCE (SIZE 1.. maxNrofCellsLTM-r18)
LTMCandidateCellInfo OPTIONAL,
]]
}
LTMCandidateCellInfo SEQUENCE {
ltm-CandidateId-r18 LTM-CandidateId-r18,
pci PhysCellId,
carrierFreq ARFCN-ValueNR,
ltm-ReferenceSignalConfiguration-r19 LTM-ReferenceSignalConfiguration OPTIONAL
TCI-state  TCI-StateInfo OPTIONAL
ltm-CSI-ResourceConfigToAddModList-r18  SEQUENCE (SIZE (1..maxNrofCSI-
ResourceConfigurations)) OF LTM-CSI-ResourceConfig
}
LTM-Information-r19 SEQUENCE {
ltm-ReferenceConfiguration-r1  OCTET STRING (CONTAINING
RRCReconfiguration),
OPTIONAL,
ltm-ReferenceSignalConfiguration-r19 LTM-ReferenceSignalConfiguration OPTIONAL
ltm-CSI-ResourceConfigToAddModList-r18  SEQUENCE (SIZE (1..maxNrofCSI-
ResourceConfigurations)) OF LTM-CSI-ResourceConfig
TCI-StateInfo TCI StateInfo OPTIONAL
}
LTM-ReferenceSignalConfiguration SEQUENCE {
ssb-ToMeasure SSB-ToMeasure
ssbFrequency ARFCN-ValueNR
OPTIONAL,
  ssbSubcarrierSpacing SubcarrierSpacing
OPTIONAL,
  smtc1 SSB-MTC
OPTIONAL,
  smtc2 SSB-MTC2
OPTIONAL,
  refFreqCSI-RS ARFCN-ValueNR
OPTIONAL,
CSI-RS-Resource-Mobility ::=  SEQUENCE {
  csi-RS-Index CSI-RS-Index,
  slotConfig CHOICE {
    ms4 INTEGER (0..31),
    ms5 INTEGER (0..39),
    ms10 INTEGER (0..79),
    ms20 INTEGER (0..159),
    ms40 INTEGER (0..319)
  },
  associatedSSB SEQUENCE {
    ssb-Index SSB-Index,
    isQuasiColocated BOOLEAN
  }
  OPTIONAL, -- Need R
  frequencyDomainAllocation CHOICE {
    row1 BIT STRING (SIZE (4)),
    row2 BIT STRING (SIZE (12))
  },+
  firstOFDMSymbolInTimeDomain INTEGER (0..13),
  sequenceGenerationConfig INTEGER (0..1023),
  ...,
  [[
  slotConfig-r17 CHOICE {
    ms4 INTEGER (0..255),
    ms5 INTEGER (0..319),
    ms10 INTEGER (0..639),
    ms20 INTEGER (0..1279),
    ms40 INTEGER (0..2559)
  }
  ]]
}
CSI-RS-Index ::==  INTEGER (0..maxNrofCSI-RS-ResourcesRRM-1)
-- TAG-LTM-CSI-RS-RESOURCE-START
      LTM-CSI-RS-Resource ::=  SEQUENCE {
        ltm-CSI-RS-ResourceId NZP-CSI-RS-ResourceId,
        resourceMapping  CSI-RS-ResourceMapping,
        periodicity AndOffset  CSI-ResourcePeriodicityAndOffset
OPTIONAL, -- Cond PeriodicOrSemiPersistent
      -- TAG-LTM-CSI-RS-RESOURCE-STOP
}
-- ASN1START
-- TAG-HANDOVER-PREPARATION-INFORMATION-STOP
-- ASN1STOP
```

HandoverPreparationInformation field descriptions are as follows:
a) as-Context: Local RAN context required by the target gNB or DU.
b) rrm-Config: Local RAN context used mainly for RRM purposes.
c) sourceConfig: The radio resource configuration as used in the source cell.
d) ue-CapabilityRAT-List: The UE radio access related capabilities concerning RATs supported by the UE (202). A gNB that retrieves MRDC related capability containers ensures that the set of included MRDC containers is consistent with respect to the feature set related information.
e) ue-InactiveTime: Duration while UE (202) has not received or transmitted any user data. Thus, the timer is still running in case e.g., UE (202) measures the neighbour cells for the HO purpose. Value s1 corresponds to 1 second, s2 corresponds to 2 seconds and so on. Value min1 corresponds to 1 minute, value min1 s20 corresponds to 1 minute and 20 seconds, value min1 s40 corresponds to 1 minute and 40 seconds and so on. Value hr1 corresponds to 1 hour, hr1 min30 corresponds to 1 hour and 30 minutes and so on.

The RRM-Config field descriptions are as follows:
a) candidateCellInfoList: A list of the best cells on each frequency for which measurement information was available.
b) LTMcandidateCellInfoList: A list of cells on a frequency for which LTM candidates are configured.
c) candidateCellInfoListSN-EUTRA: A list of EUTRA cells including serving cells and best neighbour cells on each serving frequency, for which measurement results were available. This field is only used in NE-DC.
d) Itm-ReferenceSignalConfiguration: Reference Signal configuration to be used for performing LTM measurements (L1 measurements for LTM) on the LTM candidate cells.
e) Ltm-ReferenceConfiguration: Reference configuration for generating delta (non-complete) configuration for LTM.

In an embodiment herein, the target RAN node sends an Inter-Node RRC message (such as HO Preparation ACK) within messages such as Xn HO Request ACK including reference signal configuration and TCI state configuration.

In an example, the HO Preparation ACK includes HO Preparation ACK IEs and may be defined as below in TS 38.331.

```
TABLE 15
HandoverPreparationInformationACK-IEs ::= SEQUENCE {
TCI-StateInfo TCI StateInfo OPTIONAL
ltm-ReferenceSignalConfiguration-r19 LTM-ReferenceSignalConfiguration OPTIONAL
ltm-CSI-ResourceConfigToAddModList-r18  SEQUENCE (SIZE (1..maxNrofCSI-
ResourceConfigurations)) OF LTM-CST-ResourceConfig
}
-- TAG-TCI-STATE-START
TCI-StateInfo ::= SEQUENCE {
  tci-StateId TCI-StateId,
  qcl-Type1  QCL-Info,
  qcl-Type2  QCL-Info
OPTIONAL, -- Need R
  ...,
  [[
  additionalPCI-r17 AdditionalPCIIndex-r17
OPTIONAL, -- Need R
  pathlossReferenceRS-Id-r17 PathlossReferenceRS-Id-r17
OPTIONAL, -- Cond JointTCI1
  ul-powerControl-r17 Uplink-powerControlId-r17
OPTIONAL, -- Cond JointTCI
  ]]
}
QCL-Info ::= SEQUENCE {
  cell ServCellIndex
OPTIONAL, -- Need R
  bwp-Id  BWP-Id
OPTIONAL, -- Cond CSI-RS-Indicated
  referenceSignal CHOICE {
    csi-rs NZP-CSSI-RS-ResourceId,
    ssb SSB-Index
  },
  qcl-Type ENUMERATED {typeA, typeB, typeC, typeD},
  ...
}
LTM-ReferenceSignalConfiguration SEQUENCE {
ssb-ToMeasure SSB-ToMeasure
ssbFrequency ARFCN-ValueNR
OPTIONAL,
  ssbSubcarrierSpacing SubcarrierSpacing
OPTIONAL,
  smtc1 SSB-MTC
OPTIONAL,
  smtc2 SSB-MTC2
OPTIONAL,
  refFreqCSI-RS ARFCN-ValueNR
OPTIONAL,
CSI-RS-Resource-Mobility ::= SEQUENCE {
  csi-RS-Index CSI-RS-Index,
  slotConfig CHOICE {
    ms4 INTEGER (0..31),
    ms5 INTEGER (0..39),
    ms10 INTEGER (0..79),
    ms20 INTEGER (0..159),
    ms40 INTEGER (0..319),
  },
  associatedSSB SEQUENCE {
    ssb-Index SSB-Index,
    isQuasiColocated BOOLEAN
  }
OPTIONAL, -- Need R
  frequencyDomainAllocation CHOICE {
    row1 BIT STRING (SIZE (4)),
    row2 BIT STRING (SIZE (12))
  },+
  firstOFDMSymbolInTimeDomain INTEGER (0..13),
  sequenceGenerationConfig INTEGER (0..1023),
  ...,
  [[
  slotConfig-r17 CHOICE {
    ms4  INTEGER (0..255),
    ms5  INTEGER (0..319),
    ms10  INTEGER (0..639),
    ms20  INTEGER (0..1279),
    ms40  INTEGER (0..2559)
  }
  ]]
}
CSI-RS-Index ::= INTEGER (0..maxNrofCSI-RS-ResourcesRRM-1)
-- TAG-LTM-CSI-RS-RESOURCE-START
      LTM-CSI-RS-Resource ::=  SEQUENCE {
        ltm-CSI-RS-ResourceId  NZP-CSI-RS-ResourceId,
        resourceMapping CSI-RS-ResourceMapping,
        periodicityAndOffset CSI-ResourcePeriodicityAndOffset
OPTIONAL, -- Cond PeriodicOrSemiPersistent
      -- TAG-LTM-CSI-RS-RESOURCE-STOP
}
```

The target RAN node may provide HandoverPreparationInformationACK for each LTM candidate cells.

In an embodiment, the source RAN node includes UE history information containing last visited cell list which contains last visited cell information. In an embodiment, in the last visited cell information, the source RAN includes the cause of mobility as LTM for all the cells to which the UE has moved due to LTM. In an embodiment, in the last visited cell information, the source RAN includes the cause of mobility as LTM for all the cells to which the UE (202) has moved due to Inter-gNB LTM (Xn LTM).

An example from NR TS 38.413 is given below:

(From TS 38.413) Last Visited Cell Information: The Last Visited Cell Information may contain cell specific information.

TABLE 16

| | | | IE type and | Semantics |
|---|---|---|---|---|
| IE/Group Name | Presence | Range | reference | description |
| CHOICE Last Visited | M | | | |
| Cell Information | | | | |
| >NG-RAN Cell | | | | |
| >>Last Visited NG- | M | | OCTET | Defined in |
| RAN Cell | | | STRING | TS 38.413. |
| Information | | | | |
| >E-UTRAN Cell | | | | |
| >>Last Visited E- | M | | OCTET | Defined in |
| UTRAN Cell | | | STRING | TS 36.413. |
| Information | | | | |
| >UTRAN Cell | | | | |
| >>Last Visited | M | | OCTET | Defined in |
| UTRAN Cell | | | STRING | TS 25.413. |
| Information | | | | |
| >GERAN Cell | | | | |
| >>Last Visited | M | | OCTET | Defined in |
| GERAN Cell | | | STRING | TS 36.413. |
| Information | | | | |

(From TS 38.423) Last Visited NG-RAN Cell Information: This IE contains information about a cell. In case of NR cell, this IE contains information about a set of NR cells with the same NR ARFCN for reference point A, and the Global Cell ID IE identifies one of the NR cells in the set. The information is to be used for RRM purposes.

TABLE 17

| | | | IE | | | |
|---|---|---|---|---|---|---|
| | | | type | | | |
| IE/Group | | | and | Semantics | | Assigned |
| Name | Presence | Range | reference | description | Criticality | Criticality |
| Global | M | | NG- | | — | |
| Cell ID | | | RAN | | | |
| | | | CGI | | | |
| | | | 9.3.1.73 | | | |
| Cell Type | M | | 9.3.1.98 | | — | |
| Time UE | M | | INTEGER | The | — | |
| Stayed in | | | (0 . . . 4095) | duration | | |
| Cell | | | | of time | | |
| | | | | the UE | | |
| | | | | stayed in | | |
| | | | | the cell, | | |
| | | | | or set of | | |
| | | | | NR cells | | |
| | | | | with the | | |
| | | | | same NR | | |
| | | | | ARFCN | | |
| | | | | for | | |
| | | | | reference | | |
| | | | | point | | |
| | | | | A, in | | |
| | | | | seconds. | | |
| | | | | If the | | |
| | | | | duration | | |
| | | | | is more | | |
| | | | | than | | |
| | | | | 4095s, | | |
| | | | | this IE is | | |
| | | | | set to | | |
| | | | | 4095. | | |
| Time UE | O | | INTEGER | The | — | |
| Stayed in | | | (0 . . . 40950) | duration | | |
| Cell | | | | of time | | |
| Enhanced | | | | the UE | | |
| Granularity | | | | stayed in | | |
| | | | | the cell, | | |
| | | | | or set of | | |
| | | | | NR cells | | |
| | | | | with the | | |
| | | | | same NR | | |
| | | | | ARFCN | | |
| | | | | for | | |
| | | | | reference | | |
| | | | | point | | |
| | | | | A, in | | |
| | | | | 1/10 | | |
| | | | | seconds. | | |
| | | | | If the | | |
| | | | | duration | | |
| | | | | is more | | |
| | | | | than | | |
| | | | | 4095s, | | |
| | | | | this IE is | | |
| | | | | set to | | |
| | | | | 40950. | | |
| HO Cause | O | | Cause | The | — | |
| Value | | | 9.3.1.2 | cause for | | |
| | | | | the | | |
| | | | | handover. | | |
| Last | | 0 . . . | | List of | YES | ignore |
| Visited | | <maxnoofPSCellsPerPrimary | | cells | | |
| PSCell | | CellinUEHistoryInfo> | | configured | | |
| List | | | | as | | |
| | | | | PSCells. | | |
| | | | | Most | | |
| | | | | recent | | |
| | | | | PSCell | | |
| | | | | related | | |
| | | | | information | | |
| | | | | is | | |
| | | | | added to | | |
| | | | | the top | | |
| | | | | of the | | |
| | | | | list. | | |
| >Last | M | | 9.3.1.235 | The | — | |
| Visited | | | | PSCell | | |
| PSCell | | | | related | | |
| Information | | | | information. | | |

TABLE 18

| Range bound | Explanation |
|---|---|
| maxnoofPSCellsPerPrimaryCellinUEHistoryInfo | Maximum number |
| | of last visited |
| | PSCell information |
| | records that can be |
| | reported in the |
| | IE. Value is 8. |

### Cause:

The purpose of the Cause IE is to indicate the reason for a particular event for the NGAP protocol.

TABLE 19

| IE/Group | Pre- | | IE type and | Semantics |
|---|---|---|---|---|
| Name | sence | Range | reference | description |
| CHOICE | M | | | |
| Cause | | | | |
| Group | | | | |
| >Radio | | | | |
| Network | | | | |
| Layer | | | | |
| >>Radio | M | | ENUMERATED | |
| Network | | | (Unspecified, | |
| Layer | | | TXnRELOCOverall expiry, | |
| Cause | | | Successful handover, | |
| | | | Release due to NG-RAN | |
| | | | generated reason, | |
| | | | Release due to 5GC | |
| | | | generated reason, | |
| | | | Handover cancelled, | |
| | | | Partial handover, | |
| | | | Handover failure in target | |
| | | | 5GC/NG-RAN node or target | |
| | | | system, | |
| | | | Handover target not allowed, | |
| | | | TNGRELOCoverall expiry, | |
| | | | TNGRELOCprep expiry, | |
| | | | Cell not available, | |
| | | | Unknown target ID, | |
| | | | No radio resources available | |
| | | | in target cell, | |
| | | | Unknown local UE NGAP | |
| | | | ID, | |
| | | | Inconsistent remote UE | |
| | | | NGAP ID, | |
| | | | Handover desirable for radio | |
| | | | reasons, | |
| | | | Time critical handover, | |
| | | | Resource optimisation | |
| | | | handover, | |
| | | | Reduce load in serving cell, | |
| | | | User inactivity, | |
| | | | Radio connection with UE | |
| | | | lost, | |
| | | | Radio resources not | |
| | | | available, | |
| | | | Invalid QoS combination, | |
| | | | Failure in the radio interface | |
| | | | procedure, | |
| | | | Interaction with other | |
| | | | procedure, | |
| | | | Unknown PDU Session ID, | |
| | | | Unknown QoS Flow ID, | |
| | | | Multiple PDU Session ID | |
| | | | Instances, | |
| | | | Multiple QoS Flow ID | |
| | | | Instances, | |
| | | | Encryption and/or integrity | |
| | | | protection algorithms | |
| | | | not | |
| | | | supported, | |
| | | | NG intra-system handover | |
| | | | triggered, | |
| | | | NG inter-system handover | |
| | | | triggered, | |
| | | | Xn handover triggered, | |
| | | | Not supported 5QI value, | |
| | | | UE context transfer, | |
| | | | IMS voice EPS fallback or | |
| | | | RAT fallback triggered, | |
| | | | UP integrity protection not | |
| | | | possible, | |
| | | | UP confidentiality protection | |
| | | | not possible, | |
| | | | Slice(s) not supported, | |
| | | | UE in RRC_INACTIVE | |
| | | | state not reachable, | |
| | | | Redirection, | |
| | | | Resources not available for | |
| | | | the slice(s), | |
| | | | UE maximum | |
| | | | integrity | |
| | | | protected data rate reason, | |
| | | | Release due to CN-detected | |
| | | | mobility, | |
| | | | . . . , N26 interface not | |
| | | | available, Release due to pre- | |
| | | | emption, Multiple Location | |
| | | | Reporting Reference ID | |
| | | | Instances, | |
| | | | RSN not available for the UP, | |
| | | | NPN access denied, | |
| | | | CAG only access denied, | |
| | | | Insufficient UE Capabilities, | |
| | | | RedCap UE not supported, | |
| | | | Unknown MBS Session ID, | |
| | | | Indicated MBS Session Area | |
| | | | Information not served by the | |
| | | | gNB, | |
| | | | Inconsistent slice info for the | |
| | | | session, | |
| | | | Misaligned association for | |
| | | | the multicast and unicast | |
| | | | sessions or flows, LTM, Xn | |
| | | | LTM) | |

FIG. 7 shows various hardware components of the target network entity (110b), according to the embodiments as disclosed herein. In an embodiment, the target network entity (110b) includes a processor (710), a communicator (720), a memory (730) and a LTM preparation controller (740). The processor (710) is coupled with the communicator (720), the memory (730) and the LTM preparation controller (740).

The LTM preparation controller (740) receives the handover request message from the source network entity (110a). The handover request message includes at least one of: the target cell for the LTM, the LTM candidate cell information list, the LTM reference configuration, the LTM reference signal configuration, the cause value that informs that the handover request is for the LTM, and the LTM arrival probability. In an embodiment, the LTM reference configuration, a LTM TCI state configuration and a LTM CSI resource configuration in the handover request message are encoded in a RRC format. The LTM TCI state configuration and the LTM CSI resource configuration in the handover request acknowledge are encoded in a RRC format.

Further, the LTM preparation controller (740) performs, on receiving the handover request message, at least one of: preparing for the LTM by reserving at least one resource for the LTM, replacing the prepared LTM candidate configuration, and the unsuccessful LTM preparation. Further, the LTM preparation controller (740) sends one of: the handover request acknowledge message in response to successfully preparing for the LTM by reserving the at least one resource for the LTM or replacing the prepared LTM candidate configuration based on the handover request message, and the handover preparation failure message to the source network entity (110a) when the LTM preparation is unsuccessful based on the handover request message.

In an embodiment, the handover request acknowledge message includes at least one of: the target cell for the LTM, the LTM reference signal configuration, the TCI state configuration, the maximum number of the LTM candidate cell, and the allowable of the subsequent LTM operation.

In an embodiment, the target network entity (110b) informs the configuration for the LTM CSI resource configuration for the LTM candidate cell to the source network entity (110a) in the handover request acknowledge message.

In an embodiment, the target network entity (110b) informs the TCI state configuration for the candidate cell to the source network entity (110a) in the handover request acknowledge. In an embodiment, the target network entity (110b) sets the cause value in the HO preparation failure message to inform the source network entity (110a) that the LTM preparation has failed.

In an embodiment, the target network entity (110b) informs the requested target cell identifier in the handover preparation failure message to the source network entity (110a), when the handover request message is for preparing LTM and the target network entity (110b) rejects the LTM or the failure occurs during the preparation of the LTM.

The LTM preparation controller (740) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (710) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (710) may include multiple cores and is configured to execute the instructions stored in the memory (730).

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although FIG. 7 shows various hardware components of the target network entity (110b) but it is to be understood that other embodiments are not limited thereon. In other embodiments, the target network entity (110b) may include less or more number of components. Further, the labels or names of the components are used only for illustrative purposes and does not limit the scope of the invention. One or more components can be combined together to perform the same or substantially similar function in the target network entity (110b).

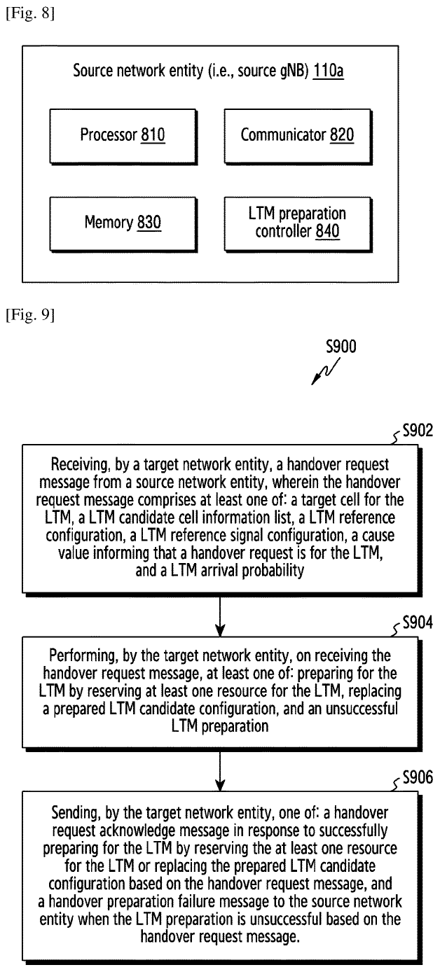

FIG. 8 shows various hardware components of the source network entity (110a), according to the embodiments as disclosed herein. In an embodiment, the source network entity (110a) includes a processor (810), a communicator (820), a memory (830) and a LTM preparation controller (840). The processor (810) is coupled with the communicator (820), the memory (830) and the LTM preparation controller (840).

The LTM preparation controller (840) sends the handover request message to the target network entity (110b). The handover request message includes at least one of: the target cell for the LTM, the LTM candidate cell information list, the LTM reference configuration, the LTM reference signal configuration, and the LTM arrival probability. In an embodiment, the LTM reference configuration, the LTM TCI state configuration and the LTM CSI resource configuration in the handover request message are encoded in the RRC format. The LTM TCI state configuration and the LTM CSI resource configuration in handover request acknowledge are encoded in the RRC format.

In an embodiment, the LTM preparation controller (840) receives the handover request acknowledge message from the target network entity (110b) based on the handover request message. In another embodiment, the LTM preparation controller (840) receives the handover preparation failure message from the target network entity (110b) based on the handover request message.

In an embodiment, the handover request acknowledge message includes at least one of: the target cell for the LTM, the LTM reference signal configuration, the TCI state configuration, the maximum number of the LTM candidate cell, and the allowable of a subsequent LTM operation.

In an embodiment, the source network entity (110a) informs the LTM reference signal configuration of the LTM candidate cell to be used for the LTM measurement for all LTM candidate cells and the source cell to the target network entity (110b) in the handover request message during the LTM preparation.

In an embodiment, the LTM candidate cell information list sending from the source network entity (110a) to the target network entity (110b) includes the candidate cell configured by the source network entity (110a) or other target network node.

In an embodiment, the source network entity (110a) informs the LTM CSI resource configuration corresponding to at least one LTM candidate cell that have been configured by the source network entity (110a) in the handover request message during the LTM preparation. In an embodiment, the source network entity (110a) informs the TCI state configuration for the candidate cell to the target network entity (110b) in the handover request message during the LTM preparation.

In an embodiment, when the source network entity (110a) sends the handover request message to the target network entity (110b) requesting for LTM preparation message, the target network entity (110b) starts a timer and stops an operation upon an expiry or stopping of the timer.

In an embodiment, the source network entity (110a) informs a probability for the LTM to be successful to the target network entity (110b).

The LTM preparation controller (840) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (810) may include one or a plurality of processors. The one or the plurality of processors may be a general-purpose processor, such as the CPU, the AP, or the like, a graphics-only processing unit such as a GPU, the VPU, and/or an AI-dedicated processor such as an NPU. The processor (810) may include multiple cores and is configured to execute the instructions stored in the memory (830).

Further, the processor (810) is configured to execute instructions stored in the memory (830) and to perform various processes. The communicator (820) is configured for communicating internally between internal hardware components and with external devices via one or more networks. The memory (830) also stores instructions to be executed by the processor (810). The memory (830) may include non-volatile storage elements. Examples of such non-volatile storage elements may include magnetic hard discs, optical discs, floppy discs, flash memories, or forms of EPROM or EEPROM memories. In addition, the memory (830) may, in some examples, be considered a non-transitory storage medium. The term “non-transitory” may indicate that the storage medium is not embodied in a carrier wave or a propagated signal. However, the term “non-transitory” should not be interpreted that the memory (830) is non-movable. In certain examples, a non-transitory storage medium may store data that can, over time, change (e.g., in Random Access Memory (RAM) or cache).

Although FIG. 8 shows various hardware components of the source network entity (110a) but it is to be understood that other embodiments are not limited thereon. In other embodiments, the source network entity (110a) may include less or more number of components. Further, the labels or names of the components are used only for illustrative purposes and does not limit the scope of the invention. One or more components can be combined together to perform the same or substantially similar function in the source network entity (110a).

FIG. 9 is a flow chart (S900) illustrating a method, implemented by the target network entity (110b), for preparing for the LTM in the wireless network (1000), according to the embodiments as disclosed herein. The operations (S902-S906) are handled by the LTM preparation controller (740).

At S902, the method includes receiving the handover request message from the source network entity (110a). The handover request message includes at least one of: the target cell for the LTM, the LTM candidate cell information list, the LTM reference configuration, the LTM reference signal configuration, the cause value informing that the handover request is for the LTM, and the LTM arrival probability. At S904, the method includes performing, on receiving the handover request message, at least one of: preparing for the LTM by reserving the at least one resource for the LTM, replacing the prepared LTM candidate configuration, and the unsuccessful LTM preparation. At S906, the method includes sending one of: the handover request acknowledge message in response to successfully preparing for the LTM by reserving the at least one resource for the LTM or replacing the prepared LTM candidate configuration based on the handover request message, and the handover preparation failure message to the source network entity (110a) when the LTM preparation is unsuccessful based on the handover request message.

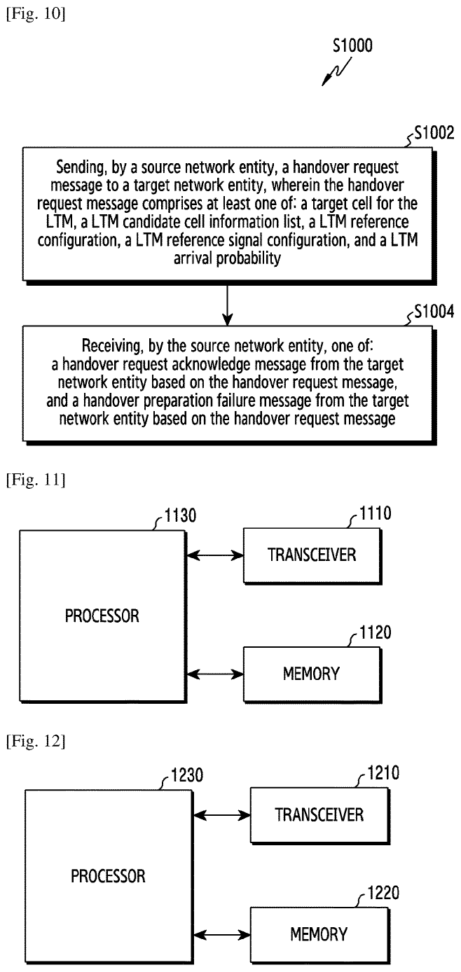

FIG. 10 is a flow chart (S1000) illustrating a method, implemented by the source network entity (110a), for preparing for the LTM in the wireless network (1000), according to the embodiments as disclosed herein. The operations (S1002-S1004) are handled by the LTM preparation controller (840).

At S1002, the method includes sending the handover request message to the target network entity (110b). The handover request message includes at least one of: the target cell for the LTM, the LTM candidate cell information list, the LTM reference configuration, the LTM reference signal configuration, and the LTM arrival probability. At S1004, the method includes receiving one of: the handover request acknowledge message from the target network entity (110b) based on the handover request message, and the handover preparation failure message from the target network entity (110b) based on the handover request message.

FIG. 11 illustrates various hardware components of a user equipment (UE), according to the embodiments as disclosed herein.

As shown in FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UE of the FIG. 2 or FIG. 3.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 illustrates various hardware components of a base station, according to the embodiments as disclosed herein.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to the base station of the FIG. 7 or FIG. 8.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

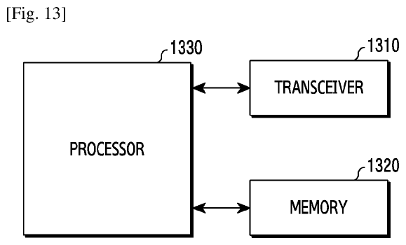

FIG. 13 illustrates various hardware components of a network entity, according to the embodiments as disclosed herein.

Referring to FIG. 13, the network entity includes a transceiver 1310, a memory 1320, and a processor 1330. The transceiver 1310, the memory 1320, and the processor 1330 of the network entity may operate according to a communication method of the network entity described above. However, the components of the network entity are not limited thereto. For example, the network entity may include fewer or a greater number of components than those described above. In addition, the processor 1330, the transceiver 1310, and the memory 1320 may be implemented as a single chip. Also, the processor 1330 may include at least one processor. Furthermore, the network entity of FIG. 13 corresponds to the network entity of the FIG. 7 or FIG. 8.

The network entity includes at least one entity of a core network. For example, the network entity includes an Access and mobility management function (AMF), a session management function (SMF), a policy control function (PCF), a network repository function (NRF), a user plane function (UPF), a network slicing selection function (NSSF), an authentication server function (AUSF), a unified data management (UDM) and a network exposure function (NEF), but the network entity is not limited thereto. For example, the network entity includes a user equipment (UE), a base station (BS).

The transceiver 1310 collectively refers to a network entity receiver and a network entity transmitter, and may transmit/receive a signal to/from a base station or a UE. The signal transmitted or received to or from the base station or the UE may include control information and data. In this regard, the transceiver 1310 may include an RF transmitter for up-converting and amplifying a frequency of a transmitted signal, and an RF receiver for amplifying low-noise and down-converting a frequency of a received signal. However, this is only an example of the transceiver 1310 and components of the transceiver 1310 are not limited to the RF transmitter and the RF receiver.

The transceiver 1310 may receive and output, to the processor 1330, a signal through a wireless channel, and transmit a signal output from the processor 1330 through the wireless channel.

The memory 1320 may store a program and data required for operations of the network entity. Also, the memory 1320 may store control information or data included in a signal obtained by the network entity. The memory 1320 may be a storage medium, such as a ROM, a RAM, a hard disk, a CD-ROM, and a DVD, or a combination of storage media.

The processor 1330 may control a series of processes such that the network entity operates as described above. For example, the transceiver 1310 may receive a data signal including a control signal, and the processor 1330 may determine a result of receiving the data signal.

The various actions, acts, blocks, steps, or the like in the flow charts (S900 and S1000) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1.-15. (canceled)

16. A method performed by a target radio access network (RAN) node in a wireless communication system, comprising:
receiving, from a source RAN node over an Xn interface, a handover request message including an L1/L2 layers triggered mobility (LTM) information request information element (IE); and
transmitting, to the source RAN node over the Xn interface, a handover request acknowledge message as a response to the handover request message, the handover request acknowledge message including an LTM information response IE.

17. The method of claim 16, wherein the handover request message includes a target cell global identifier (ID).

18. The method of claim 16,
wherein the handover request message includes an LTM reference configuration, and
wherein an assigned criticality of the LTM information request IE is rejected.

19. The method of claim 16,
wherein the LTM information request IE includes a request for a channel state information (CSI) resource configuration, and
wherein the LTM information response IE includes the CSI resource configuration including information on a synchronization signal block (SSB).

20. The method of claim 16, wherein the LTM information request IE includes an LTM cell ID.

21. A method performed by a source radio access network (RAN) node in a wireless communication system, comprising:
transmitting, to a target RAN node over an Xn interface, a handover request message including an L1/L2 layers triggered mobility (LTM) information request information element (IE); and
receiving, from the target RAN node over the Xn interface, a handover request acknowledge message as a response to the handover request message, the handover request acknowledge message including an LTM information response IE.

22. The method of claim 21,
wherein the handover request message includes a target cell global identifier (ID).

23. The method of claim 21,
wherein the handover request message includes an LTM reference configuration, and
wherein an assigned criticality of the LTM information request IE is reject.

24. The method of claim 21,
wherein the LTM information request IE includes a request for a channel state information (CSI) resource configuration, and
wherein the LTM information response IE includes the CSI resource configuration including information on a synchronization signal block (SSB).

25. The method of claim 21, wherein the LTM information request IE includes an LTM cell ID.

26. A target radio access network (RAN) node comprising:
at least one transceiver;
at least one processor communicatively coupled to the at least one transceiver;
at least one memory, communicatively coupled to the at least one processor, storing instructions executable by the at least one processor individually or in any combination to cause the target RAN node to:
receive, from a source RAN node over an Xn interface, a handover request message including an L1/L2 layers triggered mobility (LTM) information request information element (IE), and
transmit, to the source RAN node over the Xn interface, a handover request acknowledge message as a response to the handover request message, the handover request acknowledge message including an LTM information response IE.

27. The target RAN node of claim 26,
wherein the handover request message includes a target cell global identifier (ID).

28. The target RAN node of claim 26,
wherein the handover request message includes an LTM reference configuration, and
wherein an assigned criticality of the LTM information request IE is rejected.

29. The target RAN node of claim 26,
wherein the LTM information request IE includes a request for a channel state information (CSI) resource configuration, and
wherein the LTM information response IE includes the CSI resource configuration including information on a synchronization signal block (SSB).

30. The target RAN node of claim 26,
wherein the LTM information request IE includes an LTM cell ID.

31. A source radio access network (RAN) node comprising:
at least one transceiver;
at least one processor communicatively coupled to the at least one transceiver;
at least one memory, communicatively coupled to the at least one processor, storing instructions executable by the at least one processor individually or in any combination to cause the source RAN node to:
transmit, to a target RAN node over an Xn interface, a handover request message including an L1/L2 layers triggered mobility (LTM) information request information element (IE) over a Xn interface, and
receive, from the target RAN node over the Xn interface, a handover request acknowledge message as a response to the handover request message, the handover request acknowledge message including an LTM information response IE.

32. The source RAN node of claim 31,
wherein the handover request message includes a target cell global identifier (ID).

33. The source RAN node of claim 31,
wherein the handover request message includes an LTM reference configuration, and
wherein an assigned criticality of the LTM information request IE is rejected.

34. The source RAN node of claim 31,
wherein the LTM information request IE includes a request for a channel state information (CSI) resource configuration, and
wherein the LTM information response IE includes the CSI resource configuration including information on a synchronization signal block (SSB).

35. The source RAN node of claim 31,
wherein the LTM information request IE includes an LTM cell ID.
